(19) United States
(12) Patent Application Publication
(10) Pub. No.: US 2012/0172541 A1
(43) Pub. Date: Jul. 5, 2012

(54) Liquid Crystal Alignment Agent, Liquid Crystal Alignment Film Manufactured Using the Same, and Liquid Crystal Display Device Including the Liquid Crystal Alignment Film

(75) Inventors: Won-Seok DONG, Uiwang-si (KR); Bum-Jin LEE, Uiwang-si (KR); Tae-Hyoung KWAK, Uiwang-si (KR); Yo-Choul PARK, Uiwang-si (KR); Hyo-Ju SEO, Uiwang-si (KR); Hwan-Sung CHEON, Uiwang-si (KR); Won-Ho CHOI, Uiwang-si (KR)

(73) Assignee: CHEIL INDUSTRIES INC., Gumi-si (KR)

(21) Appl. No.: 13/191,068

(22) Filed: Jul. 26, 2011

(30) Foreign Application Priority Data
Dec. 30, 2010 (KR) 10-2010-0139423
Dec. 30, 2010 (KR) 10-2010-0139424

(51) Int. Cl. C08L 79/08; C08G 69/26

(52) U.S. Cl. 525/432; 528/338

(57) ABSTRACT

A liquid crystal alignment agent includes a first polymer including polyamic acid including a repeating unit represented by the following Chemical Formula 1, polyimide including a repeating unit represented by the following Chemical Formula 2, or a combination thereof. A liquid crystal alignment film manufactured using the liquid crystal alignment agent, and a liquid crystal display including the liquid crystal alignment film are also provided.

### CROSS-REFERENCE TO RELATED APPLICATIONS

This application claims priority under 35 USC Section 119 to and the benefit of Korean Patent Application Nos. 10-2010-0139423 and 10-2010-0139424 filed in the Korean Intellectual Property Office on Dec. 30, 2010, the entire disclosure of each of which is incorporated herein by reference.

### FIELD OF THE INVENTION

The present invention relates to a liquid crystal alignment agent, a liquid crystal alignment film manufactured using the same, and a liquid crystal display including the liquid crystal alignment film.

### BACKGROUND

A liquid crystal display (LCD) includes a liquid crystal alignment film, and the liquid crystal alignment film is mainly made of polymer materials. The liquid crystal alignment film plays a role of a director in aligning liquid crystal molecules. When the liquid crystal molecules are moved by the influence of an electric field to display an image, the liquid crystal alignment film allows the liquid crystal molecules to be oriented in a predetermined direction. Generally, it is necessary to uniformly align the liquid crystal molecules in order to provide uniform brightness and a high contrast ratio to the LCD.

There is an increased demand for high quality LCDs. In addition, since LCDs are rapidly becoming larger, there is an increasing requirement for a highly productive liquid crystal alignment film. Accordingly, there is a need for a liquid crystal alignment film having a low defect rate in the LCD manufacturing process, excellent electro-optical properties, high reliability, and high performance that widely satisfies different characteristics for variously-developing LCDs.

### SUMMARY OF THE INVENTION

One embodiment of the present invention provides a liquid crystal alignment agent that includes polymer prepared using diamine including a functional group having reactivity to light irradiation, which can improve light transmittance and response time; have excellent electrical properties such as voltage holding ratio and residual DC; and/or easily control the pretilt angle.

Another embodiment of the present invention provides a liquid crystal alignment film manufactured using the liquid crystal alignment agent.

Yet another embodiment of the present invention provides a liquid crystal display including the liquid crystal alignment film.

According to one embodiment of the present invention, a liquid crystal alignment agent is provided that includes a first polymer including polyamic acid including a repeating unit represented by the following Chemical Formula 1, polyimide including a repeating unit represented by the following Chemical Formula 2, or a combination thereof.

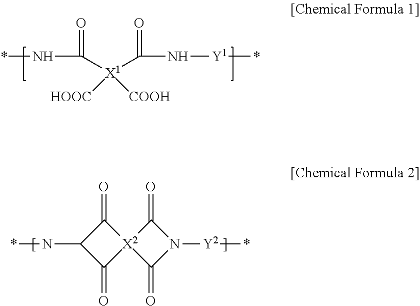

In Chemical Formula 1 and 2,

X¹ and X² are the same or different and are each independently a tetravalent organic group derived from alicyclic acid dianhydride or aromatic acid dianhydride, and

Y¹ and Y² are the same or different and are each independently a divalent organic group derived from diamine, wherein the diamine includes a diamine represented by the following Chemical Formula 3.

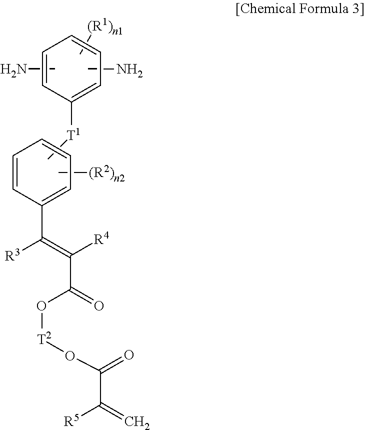

In Chemical Formula 3,

T¹ is COO, OCO or O,

T² is a single bond or a substituted or unsubstituted divalent C1 to C30 aliphatic organic group,

R¹ to R⁵ are the same or different and are independently hydrogen or substituted or unsubstituted C1 to C30 aliphatic organic group,

n₁ is an integer ranging from 0 to 3, and

n₂ is an integer ranging from 0 to 4.

In exemplary embodiments, the diamine represented by the above Chemical Formula 3 may include a compound represented by one of the following Chemical Formulae 4 to 8 or a combination thereof.

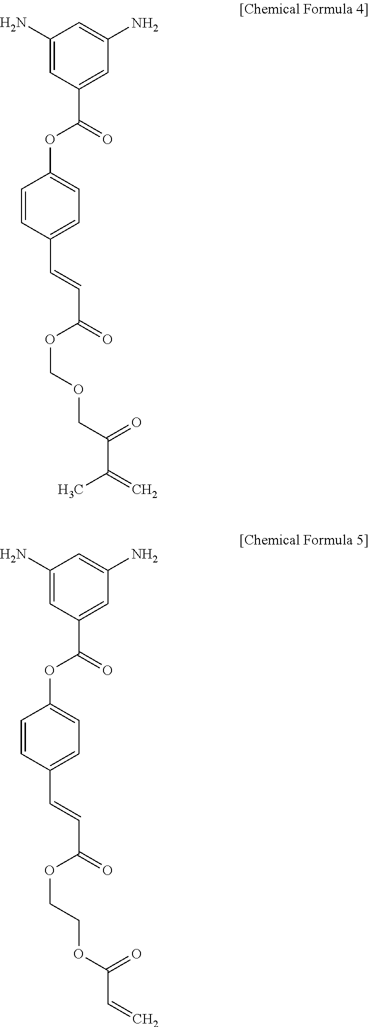

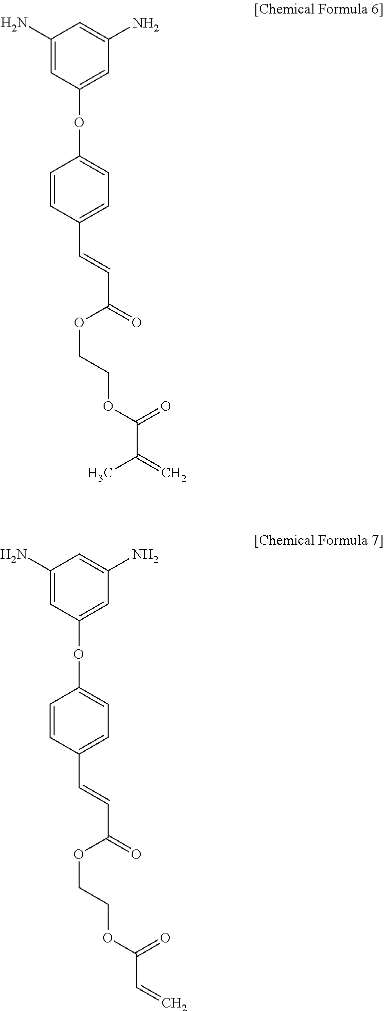

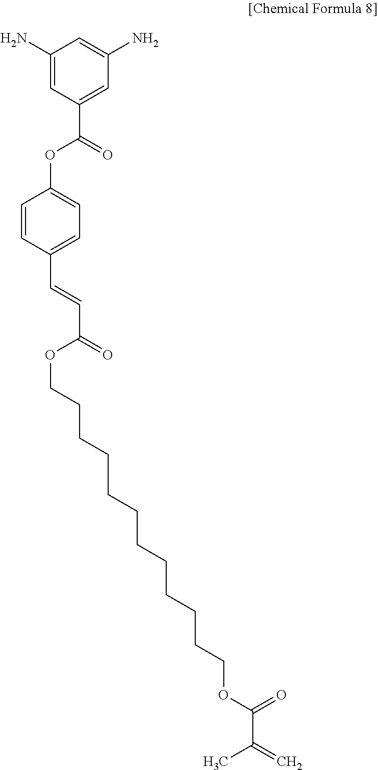

The diamine may further include an aromatic diamine represented by the following Chemical Formulae 18 to 21, a functional diamine represented by the following Chemical Formulae 22 to 24, or a combination thereof.

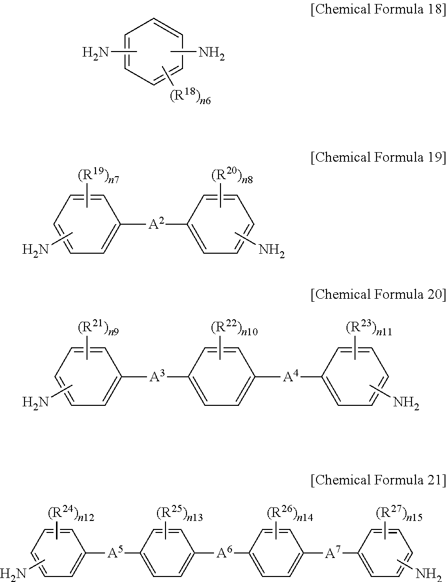

In Chemical Formulae 18 to 21,

R¹⁸ to R²⁷ are the same or different and are each independently substituted or unsubstituted alkyl, substituted or unsubstituted aryl, or substituted or unsubstituted heteroaryl, wherein the alkyl, the aryl, or the heteroaryl optionally includes —O—, —COO—, —CONH—, —OCO—, or a combination thereof,

A² to A⁷ are the same or different and are each independently a single bond, O, SO₂ or C(R¹⁰³)(R¹⁰⁴), wherein R¹⁰³ and R¹⁰⁴ are the same or different and are each independently hydrogen or substituted or unsubstituted C1 to C6 alkyl, and

n₆ to n₁₅ are each independently integers ranging from 0 to 4.

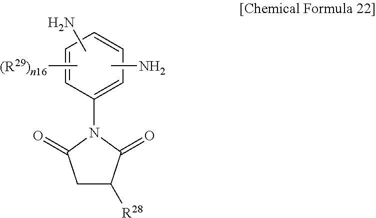

In Chemical Formula 22,

R²⁸ is hydrogen, substituted or unsubstituted C1 to C30 alkyl, substituted or unsubstituted C6 to C30 aryl, or substituted or unsubstituted C2 to C30 heteroaryl,

R²⁹ is the same or different and are each independently substituted or unsubstituted C1 to C30 alkyl, substituted or unsubstituted C6 to C30 aryl, or substituted or unsubstituted C2 to C30 heteroaryl,

n₁₆ is an integer ranging from 0 to 3.

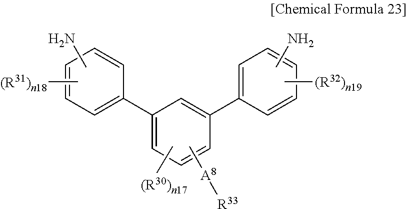

In Chemical Formula 23,

R³⁰, R³¹ and R³² are the same or different and are each independently substituted or unsubstituted alkyl, substituted or unsubstituted aryl, or substituted or unsubstituted heteroaryl,

A⁸ is a single bond, O, COO, CONN, OCO, or substituted or unsubstituted C1 to C10 alkylene,

R³³ is hydrogen, substituted or unsubstituted alkyl, substituted or unsubstituted aryl, or substituted or unsubstituted heteroaryl, wherein the alkyl, the aryl, or the heteroaryl optionally includes —O—, —COO—, —CONH—, —OCO—, or a combination thereof,

n₁₇ is an integer of 0 to 3, and

n₁₈ and n₁₉ are each independently integers ranging from 0 to 4.

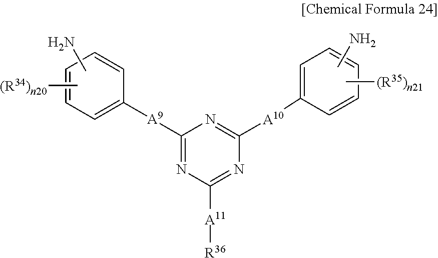

In Chemical Formula 24,

R³⁴ and R³⁵ are the same or different and are each independently substituted or unsubstituted alkyl, substituted or unsubstituted aryl, or substituted or unsubstituted heteroaryl,

n₂₀ and n₂₁ are each independently integers ranging from 0 to 4,

R³⁶ is hydrogen, substituted or unsubstituted alkyl, substituted or unsubstituted aryl, or substituted or unsubstituted heteroaryl,

A⁹ and A¹⁰ are the same or different and are each independently a single bond, O, or COO, and

A¹¹ is a single bond, O, COO, CONH or OCO.

When the diamine includes the diamine represented by the above Chemical Formula 3 and the functional diamine, the diamine may include the diamine represented by the above Chemical Formula 3 and the functional diamine at a mole ratio of about 99:1 to about 70:30.

When the diamine includes the diamine represented by the above Chemical Formula 3 and the aromatic diamine, the diamine may include the diamine represented by the above Chemical Formula 3 and the aromatic diamine at a mole ratio of about 99:1 to about 70:30.

When the diamine includes the diamine represented by the above Chemical Formula 3, the aromatic diamine and the functional diamine, the diamine may include about μmol % to about 80 mol % of the diamine represented by the above Chemical Formula 3, about 1 mol % to about 80 mol % of the aromatic diamine, and about μmol % to about 50 mol % of the functional diamine based on the total amount of the diamine.

Each of the polyamic acid including the repeating unit represented by the above Chemical Formula 1 and the polyimide including the repeating unit represented by the above Chemical Formula 2 may have a weight average molecular weight (Mw) of about 10,000 g/mol to about 300,000 g/mol, respectively.

The first polymer may include the polyamic acid including the repeating unit represented by the above Chemical Formula 1 and the polyimide including the repeating unit represented by the above Chemical Formula 2 at a weight ratio of about 1:99 to about 50:50.

The liquid crystal alignment agent may further include a second polymer including polyamic acid including the repeating unit represented by the following Chemical Formula 9, polyimide including the repeating unit represented by the following Chemical Formula 10, or a combination thereof.

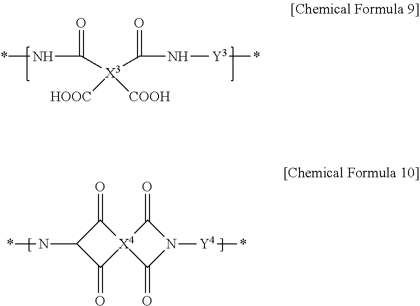

In Chemical Formulae 9 and 10,

X³ and X⁴ are the same or different and are each independently a tetravalent organic group derived from alicyclic acid dianhydride or aromatic acid dianhydride, and

Y³ and Y⁴ are the same or different and are each independently a divalent organic group derived from diamine.

Each of the polyamic acid including the repeating unit represented by the above Chemical Formula 9 and the polyimide including the repeating unit represented by the above Chemical Formula 10 may have a weight average molecular weight of about 10,000 g/mol to about 300,000 g/mol, respectively.

The second polymer may include the polyamic acid including the repeating unit represented by the above Chemical Formula 9 and the polyimide including the repeating unit represented by the above Chemical Formula 10 at a weight ratio of about 1:99 to about 50:50.

The liquid crystal alignment agent may include the first polymer and the second polymer at a weight ratio of about 10:90 to about 50:50.

The liquid crystal alignment agent may have a solid content of about 1 wt % to about 30 wt %.

According to another embodiment of the present invention, a liquid crystal alignment film manufactured by applying the liquid crystal alignment agent to a substrate is provided.

According to yet another embodiment of the present invention, a liquid crystal display including the liquid crystal alignment film is provided.

Hereinafter, further embodiments of the present invention will be described in detail.

The liquid crystal alignment agent can improve light transmittance, response time, liquid crystal alignment properties, and/or the electro-optical properties and can easily control the pretilt angle. Accordingly, the liquid crystal alignment agent may be used in a vertical alignment mode (VA mode) liquid crystal alignment film and/or a twisted nematic mode (TN mode) liquid crystal alignment film.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “substituted” may refer to one substituted with a substituent including halogen (F, Br, Cl or I), hydroxy, nitro, cyano, amino (NH₂, NH(R¹⁰⁰) or N(R¹⁰¹)(R¹⁰²), wherein R¹⁰⁰, R¹⁰¹, and R¹⁰² are the same or different and are each independently C1 to C10 alkyl), amidino, hydrazine, hydrazone, carboxyl, substituted or unsubstituted alkyl, substituted or unsubstituted haloalkyl, substituted or unsubstituted alkoxy, a substituted or unsubstituted alicyclic organic group, substituted or unsubstituted aryl, substituted or unsubstituted alkenyl, substituted or unsubstituted alkynyl, substituted or unsubstituted heteroaryl, substituted or unsubstituted heterocycloalkyl, or a combination thereof, in place of at least one of hydrogen of a functional group.

As used herein, when a specific definition is not otherwise provided, the term “alkyl” may refer to C1 to C30 alkyl, for example C1 to C20 alkyl, the term “cycloalkyl” may refer to C3 to C30 cycloalkyl, for example C3 to C20 cycloalkyl, the term “heterocycloalkyl” may refer to C2 to C30 heterocycloalkyl, for example C2 to C20 heterocycloalkyl, the term “alkylene” may refer to C1 to C30 alkylene, for example C1 to C20 alkylene, the term “alkoxy” may refer to C1 to C30 alkoxy, for example C1 to C20 alkoxy, the term “cycloalkylene” may refer to C3 to C30 cycloalkylene, for example C3 to C20 cycloalkylene, the term “heterocycloalkylene” may refer to C2 to C30 heterocycloalkylene, for example C2 to C20 heterocycloalkylene, the term “aryl” may refer to C6 to C30 aryl, for example C6 to C20 aryl, the term “heteroaryl” may refer to C2 to C30 heteroaryl, for example C2 to C18 heteroaryl, the term “arylene” may refer to C6 to C30 arylene, for example C6 to C20 arylene, the term “heteroarylene” may refer to C2 to C30 heteroarylene, for example C2 to C20 heteroarylene, the term “alkylaryl” may refer to C7 to C30 alkylaryl, for example C7 to C20 alkylaryl, and the term “halogen” may refer to F, Cl, Br, or I.

As used herein, when a specific definition is not otherwise provided, the terms heterocycloalkyl, heterocycloalkylene, heteroaryl, and heteroarylene may refer to cycloalkyl, cycloalkylene, aryl, and arylene, respectively, including 1 to 3 heteroatoms including N, O, S, Si, P or a combination thereof, in place of one or more carbon ring atoms.

As used herein, when a specific definition is not otherwise provided, the term “aliphatic” may refer to C1 to C30 alkyl, C2 to C30 alkenyl, C2 to C30 alkynyl, C1 to C30 alkylene, C2 to C30 alkenylene, or C2 to C30 alkynylene, for example C1 to C20 alkyl, C2 to C20 alkenyl, C2 to C20 alkynyl, C1 to C20 alkylene, C2 to C20 alkenylene, or C2 to C20 alkynylene, the term “alicyclic” may refer to C3 to C30 cycloalkyl, C3 to C30 cycloalkenyl, C3 to C30 cycloalkynyl, C3 to C30 cycloalkylene, C3 to C30 cycloalkenylene, or C3 to C30 cycloalkynylene, for example C3 to C20 cycloalkyl, C3 to C20 cycloalkenyl, C3 to C20 cycloalkynyl, C3 to C20 cycloalkylene, C3 to C20 cycloalkenylene, or C3 to C20 cycloalkynylene, and the term “aromatic” may refer to C6 to C30 aryl, C2 to C30 heteroaryl, C6 to C30 arylene, or C2 to C30 heteroarylene, for example C6 to C16 aryl, C2 to C16 heteroaryl, C6 to C16 arylene, or C2 to C16 heteroarylene.

As used herein, when a specific definition is not otherwise provided, the term “combination” may refer to mixture or copolymerization; in case of an alicyclic organic group and an aromatic organic group, a fused ring of two or more rings, or two or more rings linked by a single bond, O, S, C(═O), CH(OH), S(═O), S(═O)₂, Si(CH₃)₂, (CH₂)ₚ (wherein, 1≦p≦2), (CF)_{2q} (wherein, 1≦q≦2), C(CH₃)₂, C(CF₃)₂, C(CH₃)(CF₃), or C(═O)NH. As used herein, when a specific definition is not otherwise provided, the term “copolymerization” may refer to block copolymerization or to random copolymerization, and “copolymer” may refer to a block copolymer or to a random copolymer.

“*” denotes a position linked to the same or different atom or Chemical Formula.

The liquid crystal alignment agent according to one embodiment of the present invention includes a first polymer including polyamic acid including a repeating unit represented by the following Chemical Formula 1, polyimide including a repeating unit represented by the following Chemical Formula 2, or a combination thereof.

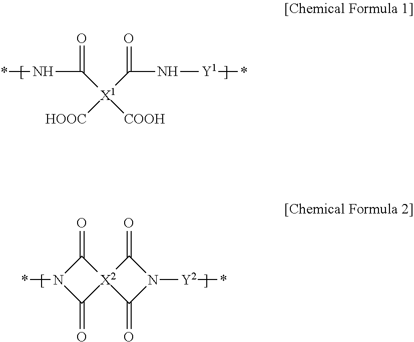

In Chemical Formulae 1 and 2,

X¹ and X² are the same or different and are each independently a tetravalent organic group derived from alicyclic acid dianhydride or aromatic acid dianhydride. X¹ may be the same or different in each repeating unit, and X² may be the same or different in each repeating unit.

Y¹ and Y² are the same or different and are each independently a divalent organic group derived from diamine, and the diamine includes one represented by the following Chemical Formula 3. Y¹ may be the same or different in each repeating unit, and Y² may be the same or different in each repeating unit.

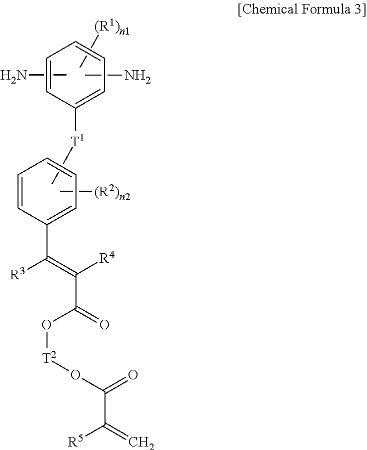

In Chemical Formula 3,

T¹ is COO, OCO or O, for example COO or O.

T² is a single bond or a substituted or unsubstituted divalent C1 to C30 aliphatic organic group, for example substituted or unsubstituted divalent C1 to C30 alkylene, and as another example substituted or unsubstituted divalent C1 to C15 alkylene.

R¹ to R⁵ are the same or different and are independently hydrogen or substituted or unsubstituted C1 to C30 aliphatic organic group, for example hydrogen or substituted or unsubstituted C1 to C10 alkyl, and as another example hydrogen or substituted or unsubstituted C1 to C5 alkyl.

n₁ is an integer ranging from 0 to 3, and

n₂ is an integer ranging from 0 to 4.

The diamine represented by the above Chemical Formula 3 may include a residual group derived from cinnamate and a residual group derived from acrylate or methacrylate at its terminal end. The residual group derived from cinnamate, the residual group derived from acrylate and the residual group derived from methacrylate can undergo a reaction by photo-radiation. Accordingly, when the liquid crystal alignment agent is prepared by using the diamine represented by Chemical Formula 3, sensitivity may be improved, and molecular alignment of liquid crystal may be induced in one direction during irradiation, so it may effectively improve the alignment properties.

The diamine represented by the above Chemical Formula 3 may include a compound represented by the following Chemical Formulae 4 to 8, or a combination thereof, but is not limited thereto.

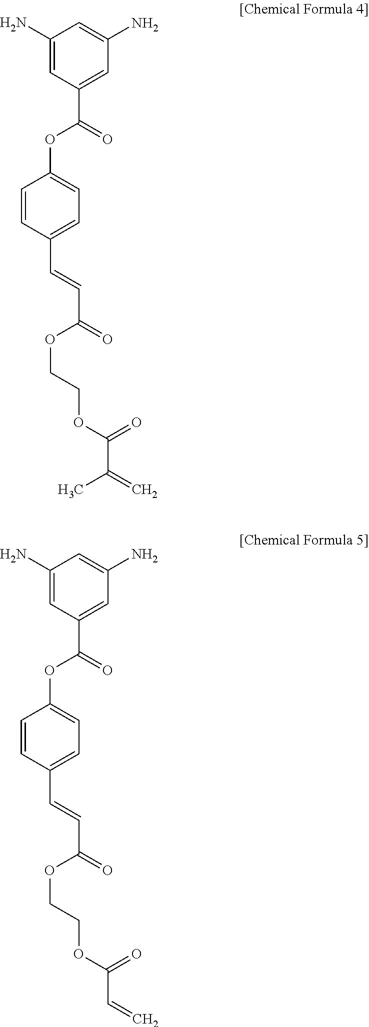

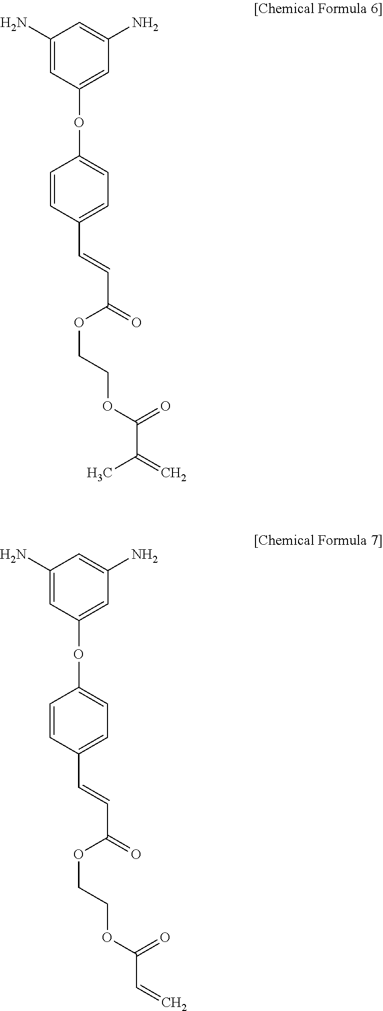

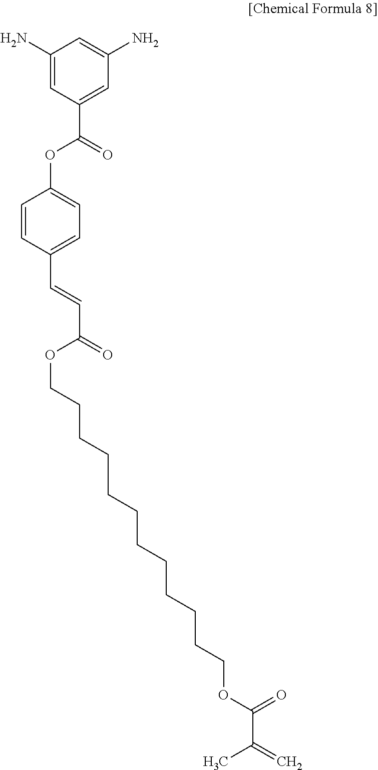

The polyamic acid and the polyimide may be simply mixed or copolymerized.

Hereinafter, each component is described in detail.

Polymer

The liquid crystal alignment agent may include the first polymer.

The polymer in the liquid crystal alignment agent may further include a second polymer including polyamic acid including the repeating unit represented by the following Chemical Formula 9, polyimide including the repeating unit represented by the following Chemical Formula 10, or a combination thereof.

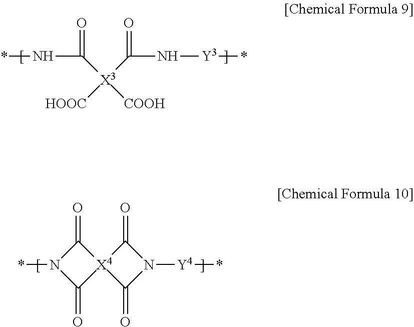

In Chemical Formulae 9 and 10,

X³ and X⁴ are the same or different and are each independently a tetravalent organic group derived from alicyclic acid dianhydride or aromatic acid dianhydride. X³ may be the same or different in each repeating unit, and X⁴ may be the same or different in each repeating unit.

Y³ and Y⁴ are the same or different and are each independently a divalent organic group derived from diamine. Y³ may be the same or different in each repeating unit, and Y⁴ may be the same or different in each repeating unit.

The first polymer and the second polymer are described separately hereinafter.

First Polymer

The first polymer includes polyamic acid including the repeating unit represented by the above Chemical Formula 1, polyimide including the repeating unit represented by the above Chemical Formula 2, or a combination thereof.

The polyamic acid including a repeating unit represented by Chemical Formula 1 may be synthesized from acid dianhydride and diamine. The method of preparing polyamic acid by copolymerizing the acid dianhydride and the diamine is not specifically limited as long as it synthesizes the polyamic acid.

The polyimide including a repeating unit represented by Chemical Formula 2 may be prepared by imidizing the polyamic acid including a repeating unit represented by Chemical Formula 1. Methods of prepaing polyimide by imidizing polyamic acid are well known to the one of ordinary skill in this art, so the details are omitted.

Exemplary acid dianhydrides may include without limitation alicyclic acid dianhydrides, aromatic acid dianhydrides, and the like, and mixtures thereof.

The diamine may include diamine represented by Chemical Formula 3 or a mixture of the same with at least one of predetermined functional diamine and predetermined aromatic diamine.

Exemplary alicyclic acid dianhydrides may include without limitation 1,2,3,4-cyclobutanetetracarboxylic acid dianhydride (CBDA), 5-(2,5-dioxotetrahydrofuryl)-3-methylcyclohexene-1,2-dicarboxylic acid anhydride (DOCDA), bicyclooctene-2,3,5,6-tetracarboxylic acid dianhydride (BODA), 1,2,3,4-cyclopentanetetracarboxylic acid dianhydride (CPDA), 1,2,4,5-cyclohexanetetracarboxylic acid dianhydride (CHDA), 1,2,4-tricarboxyl-3-methylcarboxylcyclopentane dianhydride, 1,2,3,4-tetracarboxyl cyclopentane dianhydride, and the like, and mixtures of two or more.

The tetravalent organic group derived from the alicyclic acid dianhydride may include at least one of the functional groups represented by the following Chemical Formulae 11 to 15, or a combination thereof, but is not limited thereto.

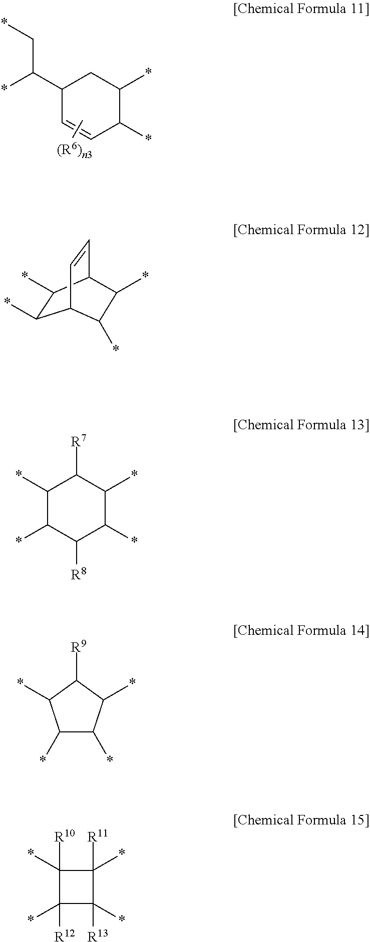

In Chemical Formulae 11 to 15,

R⁶ are the same or different and are independently a substituted or unsubstituted alkyl, substituted or unsubstituted aryl, or substituted or unsubstituted heteroaryl,

n₃ is an integer ranging from 0 to 3, and

R⁷ to R¹³ are the same or different and are independently hydrogen, substituted or unsubstituted alkyl, substituted or unsubstituted aryl, or substituted or unsubstituted heteroaryl.

When n₃ is an integer of 2 or more, a plurality of R⁶ may be the same or different.

Exemplary aromatic acid dianhydrides may include without limitation pyromellitic acid dianhydride (PMDA), biphthalic acid dianhydride (BPDA), oxydiphthalic acid dianhydride (ODPA), benzophenonetetracarboxylic acid dianhydride (BTDA), hexafluoroisopropylidene diphthalic acid dianhydride (6-FDA), and the like, and mixtures of two or more.

The tetravalent organic group derived from the aromatic acid dianhydride may include at least one of a functional group represented by the following Chemical Formula 16 and a functional group represented by the following Chemical Formula 17, or a combination thereof, but is not limited thereto.

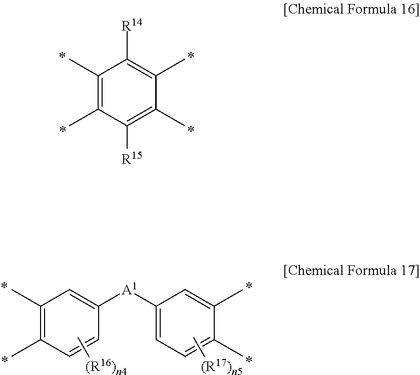

In Chemical Formulae 16 and 17,

R¹⁴ and R¹⁵ are the same or different and are each independently hydrogen, substituted or unsubstituted alkyl, substituted or unsubstituted aryl, or substituted or unsubstituted heteroaryl,

R¹⁶ and R¹⁷ are the same or different and are independently substituted or unsubstituted alkyl, substituted or unsubstituted aryl, or substituted or unsubstituted heteroaryl,

n₄ and n₅ are each independently integers ranging from 0 to 3, and

A¹ is a single bond, O, CO, substituted or unsubstituted C1 to C6 alkylene (e.g., C(CF₃)₂), substituted or unsubstituted C3 to C30 cycloalkylene, or substituted or unsubstituted C2 to C30 heterocycloalkylene.

When n₄ is an integer of 2 or more, a plurality of R¹⁶ may be the same or different. When n₅ is an integer of 2 or more, a plurality of R¹⁷ may be the same or different.

Exemplary aromatic diamines may include without limitation paraphenylenediamine (p-PDA), 4,4-methylene dianiline (MDA), 4,4-oxydianiline (ODA), metabisaminophenoxydiphenylsulfone (m-BAPS), parabisaminophenoxydiphenylsulfone (p-BAPS), 2,2-bis[(aminophenoxy)phenyl]propane (BAPP), 2,2-bisaminophenoxyphenylhexafluoropropane (HF-BAPP), 1,4-diamino-2-methoxybenzene, and the like, and mixtures of two or more.

The aromatic diamine may include at least one of the compounds represented by the following Chemical Formulae 18 to 21, or a combination thereof, but is not limited thereto. The polyamic acid and the polyimide may include a divalent organic group derived from the aromatic diamine. When the polyamic acid and the polyimide include the divalent organic group derived from the aromatic diamine, it may improve chemical resistance, thermal stability, and mechanical properties of the liquid crystal alignment agent and the liquid crystal alignment film formed from the liquid crystal alignment agent.

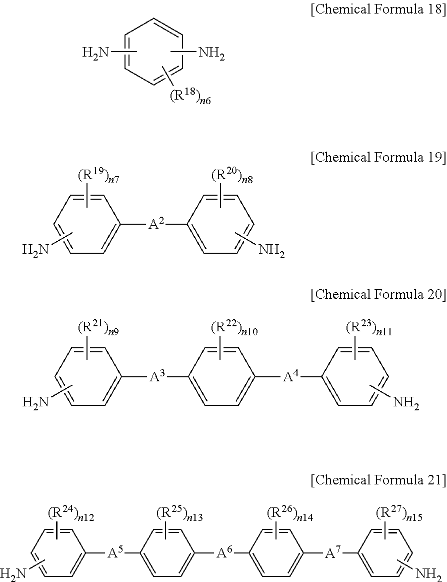

In Chemical Formulae 18 to 21,

R¹⁸ to R²⁷ are the same or different and are each independently substituted or unsubstituted alkyl, substituted or unsubstituted aryl, or substituted or unsubstituted heteroaryl, wherein the alkyl, the aryl, or the heteroaryl optionally include —O—, —COO—, —CONH—, —OCO—, or a combination thereof,

A² to A⁷ are the same or different and are each independently a single bond, O, SO₂ or C(R¹⁰³)(R¹⁰⁴), for example C(CF₃)₂, wherein R¹⁰³ and R¹⁰⁴ are the same or different and are each independently hydrogen or substituted or unsubstituted C1 to C6 alkyl, and

n₆ to n₁₅ are each independently integers ranging from 0 to 4.

When n₆ is an integer of 2 or more, a plurality of R¹⁸ may be the same or different. When n₇ to n₁₅ are an integer of 2 or more, a plurality of R¹⁹ to R²⁷ may be the same or different, respectively.

The functional diamine may include at least one of the compounds represented by the following Chemical Formulae 22 to 24, or a combination thereof, but is not limited thereto. The polyamic acid and the polyimide may include a divalent organic group derived from the functional diamine. When the polyamic acid and the polyimide includes the divalent organic group derived from the functional diamine, it may improve liquid crystal alignment properties, chemical resistance, and electro-optical properties, and it may easily control pretilt angle and accomplish a high pretilt angle. Accordingly, the liquid crystal alignment agent may be used for a vertical alignment mode liquid crystal alignment film and/or a twisted nematic mode liquid crystal alignment film.

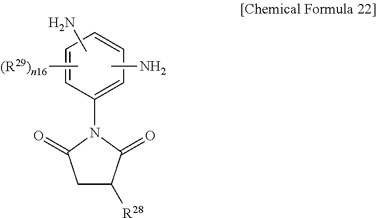

In Chemical Formula 22,

R²⁸ is hydrogen, substituted or unsubstituted C1 to C30 alkyl, substituted or unsubstituted C6 to C30 aryl, or substituted or unsubstituted C2 to C30 heteroaryl,

R²⁹ is the same or different and is each independently substituted or unsubstituted C1 to C30 alkyl, substituted or unsubstituted C6 to C30 aryl, or substituted or unsubstituted C2 to C30 heteroaryl, and

n₁₆ is an integer ranging from 0 to 3.

When n₁₆ is an integer of 2 or more, a plurality of R²⁹ may be the same or different.

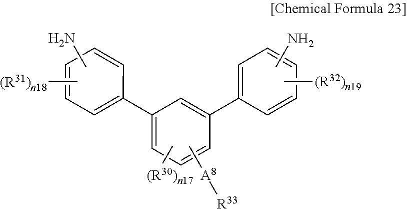

In Chemical Formula 23,

R³⁰, R³¹ and R³² are the same or different and are each independently substituted or unsubstituted alkyl, substituted or unsubstituted aryl, or substituted or unsubstituted heteroaryl,

A⁸ is a single bond, O, COO, CONN, OCO, or substituted or unsubstituted C1 to C10 alkylene,

R³³ is hydrogen, substituted or unsubstituted alkyl, substituted or unsubstituted aryl, or substituted or unsubstituted heteroaryl, wherein the alkyl, the aryl, or the heteroaryl optionally includes —O—, —COO—, —CONH—, —OCO—, or a combination thereof,

n₁₇ is an integer of 0 to 3, and,

n₁₈ and n₁₉ are each independently integers ranging from 0 to 4.

When n₁₇ is an integer of 2 or more, a plurality of R³ may be the same or different. When n₁₈ and n₁₉ are integers of 2 or more, a plurality of R³¹ and R³² may be the same or different, respectively.

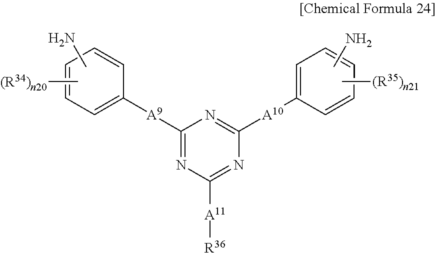

In Chemical Formula 24,

R³⁴ and R³⁵ are the same or different, and are each independently substituted or unsubstituted alkyl, substituted or unsubstituted aryl, or substituted or unsubstituted heteroaryl,

n₂₀ and n₂₁ are each independently integers ranging from 0 to 4

R³⁶ is hydrogen, substituted or unsubstituted alkyl, substituted or unsubstituted aryl, or substituted or unsubstituted heteroaryl,

A⁹ and A¹⁰ are the same or different and are independently a single bond, O or COO, and

A¹¹ is a single bond, O, COO, CONN or OCO.

When n₂₀ is an integer of 2 or more, a plurality of R³⁴ may be the same or different. When n₂₁ is an integer of 2 or more, a plurality of R³⁵ may be the same or different.

The diamine may include diamine represented by the above Chemical Formula 3 singularly, or it may also use the aromatic diamine, the functional diamine, or a combination thereof together with the diamine represented by the above Chemical Formula 3.

When the diamine includes the diamine represented by the above Chemical Formula 3 and the functional diamine, the diamine may include the diamine represented by the above Chemical Formula 3 and the functional diamine at a mole ratio of about 99:1 to about 70:30, for example about 80:20 to about 70:30.

In some embodiments, the diamine including the diamine represented by the above Chemical Formula 3 and the functional diamine may include the diamine represented by the above Chemical Formula 3 in an amount of about 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 mol %. Further, according to some embodiments of the present invention, the amount of the diamine represented by the above Chemical Formula 3 can be in a range from about any of the foregoing amounts to about any other of the foregoing amounts.

In some embodiments, the diamine including the diamine represented by the above Chemical Formula 3 and the functional diamine may include the functional diamine in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 mol %. Further, according to some embodiments of the present invention, the amount of the functional diamine can be in a range from about any of the foregoing amounts to about any other of the foregoing amounts.

When the diamine represented by the above Chemical Formula 3 and the functional diamine are included in an amount within the above range, the liquid crystal alignment agent can have excellent photo-reactivity and thus can be exposed to a wide range of a photo-radiation conditions, and can be applied to various modes due to easy control of a pretilt angle.

When the diamine includes the diamine represented by the above Chemical Formula 3 and the aromatic diamine, the diamine may include the diamine represented by the above Chemical Formula 3 and the aromatic diamine at a mole ratio of about 99:1 to about 70:30, for example about 80:20 to about 70:30.

In some embodiments, the diamine including the diamine represented by the above Chemical Formula 3 and the aromatic diamine may include the diamine represented by the above Chemical Formula 3 in an amount of about 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 mol %. Further, according to some embodiments of the present invention, the amount of the diamine represented by the above Chemical Formula 3 can be in a range from about any of the foregoing amounts to about any other of the foregoing amounts.

In some embodiments, the diamine including the diamine represented by the above Chemical Formula 3 and the aromatic diamine may include the aromatic diamine in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 mol %. Further, according to some embodiments of the present invention, the amount of the aromatic diamine can be in a range from about any of the foregoing amounts to about any other of the foregoing amounts.

When the diamine represented by the above Chemical Formula 3 and the aromatic diamine are included in an amount within the above range, the liquid crystal alignment agent and a liquid crystal alignment film manufactured using the same may have excellent chemical resistance, electro-optical properties, thermal stability, and/or mechanical properties. When the diamine includes the aromatic diamine and the functional diamine, the diamine represented by the above Chemical Formula 3 is included in about 1 mol % to about 80 mol %; the aromatic diamine is included in about 1 mol % to about 80 mol %; and the functional diamine is included in about 1 mol % to about 50 mol % based on the total amount of diamine.

In some embodiments, the diamine including the diamine represented by the above Chemical Formula 3, the aromatic diamine, and the functional diamine may include the diamine represented by the above Chemical Formula 3 in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 mol %. Further, according to some embodiments of the present invention, the amount of the diamine represented by the above Chemical Formula 3 can be in a range from about any of the foregoing amounts to about any other of the foregoing amounts.

In some embodiments, the diamine including the diamine represented by the above Chemical Formula 3, the aromatic diamine, and the functional diamine may include the aromatic diamine in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 mol %. Further, according to some embodiments of the present invention, the amount of the aromatic diamine can be in a range from about any of the foregoing amounts to about any other of the foregoing amounts.

In some embodiments, the diamine including the diamine represented by the above Chemical Formula 3, the aromatic diamine, and the functional diamine may include the functional diamine in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 mol %. Further, according to some embodiments of the present invention, the amount of the functional diamine can be in a range from about any of the foregoing amounts to about any other of the foregoing amounts.

When each diamine is included in an amount within the above ranges, it may control the pretilt angle and effectively accomplish the high pretilt angle; and it may effectively improve liquid crystal alignment properties, chemical resistance, electro-optical characteristics, thermal stability, and mechanical properties. In addition, the process may be improved by increasing the solubility.

The polyamic acid including the repeating unit represented by the above Chemical Formula 1 and the polyimide including the repeating unit represented by the above Chemical Formula 2 may each have a weight average molecular weight of about 10,000 g/mol to about 300,000 g/mol, respectively. When the polyamic acid including the repeating unit represented by the above Chemical Formula 1 and the polyimide including the repeating unit represented by the above Chemical Formula 2 have a weight average molecular weight within the above range, reliability and electro-optical properties may be improved and excellent chemical resistance and/or stable pretilt angle even after driving the liquid crystal display may be provided.

The first polymer may include polyamic acid including the repeating unit represented by the above Chemical Formula 1 and polyimide including the repeating unit represented by the above Chemical Formula 2. In exemplary embodiments, the first polymer may include the polyamic acid including the repeating unit represented by the above Chemical Formula 1 and the polyimide including the repeating unit represented by the above Chemical Formula 2 at a weight ratio of about 1:99 to about 50:50, for example about 10:90 to about 50:50.

In some embodiments, the first polymer may include polyamic acid including the repeating unit represented by the above Chemical Formula 1 in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the polyamic acid including the repeating unit represented by the above Chemical Formula 1 can be in a range from about any of the foregoing amounts to about any other of the foregoing amounts.

In some embodiments, the first polymer may include polyimide including the repeating unit represented by the above Chemical Formula 2 in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the polyimide including the repeating unit represented by the above Chemical Formula 2 can be in a range from about any of the foregoing amounts to about any other of the foregoing amounts.

When the first polymer includes the polyamic acid including the repeating unit represented by the above Chemical Formula 1 and the polyimide including the repeating unit represented by the above Chemical Formula 2 in an amount within the above range, alignment stability may be improved.

Second Polymer

The second polymer may include polyamic acid including the repeating unit represented by the above Chemical Formula 9, polyimide including the repeating unit represented by the above Chemical Formula 10, or a combination thereof.

The polyamic acid including a repeating unit represented by Chemical Formula 9 may be synthesized from acid dianhydride and diamine. The method of preparing polyamic acid by copolymerizing the acid dianhydride and the diamine is not specifically limited as long as it synthesizes the polyamic acid.

The polyimide including a repeating unit represented by Chemical Formula 10 may be prepared by imidizing the polyamic acid including a repeating unit represented by Chemical Formula 9. The method of prepaing polyimide by imidizing polyamic acid is well known to the one of ordinary skill in the art, so the details are omitted.

Exemplary acid dianhydrides may include without limitation alicyclic acid dianhydrides, aromatic acid dianhydrides, and the like, and mixtures thereof.

Hereinafter, when a description is not otherwise provided, the alicyclic acid dianhydride, the tetravalent organic group derived from the alicyclic acid dianhydride, the aromatic acid dianhydride, and the tetravalent organic group derived from the aromatic acid dianhydride are the same as described with regard to the first polymer.

Exemplary diamines may include without limitation functional diamines, aromatic diamines, and the like, and combinations thereof.

Hereinafter, when a description is not otherwise provided, the functional diamine, the divalent organic group derived from the functional diamine, the aromatic diamine, and the divalent organic group derived from the aromatic diamine are the same as described with regard to the first polymer.

The polyamic acid including the repeating unit represented by the above Chemical Formula 9 and polyimide including the repeating unit represented by the above Chemical Formula 10 may each have a weight average molecular weight of about 10,000 g/mol to about 300,000 g/mol, respectively. When the polyamic acid including the repeating unit represented by the above Chemical Formula 9 and polyimide including the repeating unit represented by the above Chemical Formula 10 have a weight average molecular weight within the above range, reliability and electro-optical properties may be improved and excellent chemical resistance and stable pretilt angle even after driving the liquid crystal display may be provided.

The second polymer may include polyamic acid including the repeating unit represented by the above Chemical Formula 9 and polyimide including the repeating unit represented by the above Chemical Formula 10. In exemplary embodiments, the polyamic acid including the repeating unit represented by the above Chemical Formula 9 and polyimide including the repeating unit represented by the above Chemical Formula 10 may be included at a weight ratio of about 1:99 to about 50:50, for example about 10:90 to about 50:50.

In some embodiments, the second polymer may include polyamic acid including the repeating unit represented by the above Chemical Formula 9 in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the polyamic acid including the repeating unit represented by the above Chemical Formula 9 can be in a range from about any of the foregoing amounts to about any other of the foregoing amounts.

In some embodiments, the second polymer may include polyimide including the repeating unit represented by the above Chemical Formula 10 in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the polyimide including the repeating unit represented by the above Chemical Formula 10 can be in a range from about any of the foregoing amounts to about any other of the foregoing amounts.

When the polyamic acid including the repeating unit represented by the above Chemical Formula 9 and the polyimide including the repeating unit represented by the above Chemical Formula 10 are included in an amount within the above ranges, alignment stability may be improved. When the liquid crystal alignment agent includes both the first polymer and the second polymer, the liquid crystal alignment agent may include the first polymer and the second polymer at a weight ratio of about 10:90 to about 50:50, for example about 20:80 to about 40:60.

In some embodiments, the liquid crystal alignment agent may include the first polymer in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the first polymer can be in a range from about any of the foregoing amounts to about any other of the foregoing amounts.

In some embodiments, the liquid crystal alignment agent may include the second polymer in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the second polymer can be in a range from about any of the foregoing amounts to about any other of the foregoing amounts.

When the first polymer and the second polymer are included in an amount within the above ranges, the liquid crystal alignment agent can position residual groups capable of a photo-radiation reaction at a surface of a liquid crystal alignment film, and thus can efficiently provide liquid crystal alignment properties through a polymer having residual groups capable of a photo-radiation reaction even in small amounts. The liquid crystal alignment agent can include the polymer in an amount of about 1 wt % to about 30 wt %, for example about 3 wt % to about 20 wt %.

In some embodiments, the liquid crystal alignment agent may include the polymer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the polymer can be in a range from about any of the foregoing amounts to about any other of the foregoing amounts.

When the polymer is included in an amount within the above range, printability and liquid crystal alignment properties may be improved.

Solvent

The liquid crystal alignment agent according to one embodiment of the present invention includes a suitable solvent to dissolve the polymer.

Exemplary solvents suitable for dissolving the polymer may include without limitation N-methyl-2-pyrrolidone; N,N-dimethyl acetamide; N,N-dimethyl formamide; dimethyl sulfoxide; γ-butyrolactone; tetrahydrofuran (THF); and phenol-based solvents such as meta cresol, phenol, halgenated phenol, and the like, and combinations thereof.

The solvent may further include 2-butyl cellosolve (2-BC), which may improve printability. The solvent may include 2-butyl cellosolve in an amount of about 1 wt % to about 60 wt %, for example about 10 wt % to about 60 wt % based on the total weight of the solvent including 2-butyl cellosolve. When the 2-butyl cellosolve is included in an amount within the above range, it may easily improve printability.

In addition, the solvent may further include a poor solvent in an appropriate ratio as long as the soluble polymer is not precipitated. Exemplary poor solvents include without limitation alcohols, ketones, esters, ethers, hydrocarbons, halgenated hydrocarbons, and the like, and combinations thereof. The poor solvents may decrease the surface energy of liquid crystal alignment agent to improve spreadability and flatness during coating.

The solvent may include the poor solvent in an amount of about 1 wt % to about 90 wt %, for example, about 1 wt % to about 70 wt %, based on the total amount of solvent including the poor solvent.

Exemplary poor solvents may include without limitation methanol, ethanol, isopropanol, cyclohexanol, ethyleneglycol, propyleneglycol, 1,4-butanediol, triethyleneglycol, acetone, methylethylketone, cyclohexanone, methylacetate, ethylacetate, butylacetate, diethyloxalate, malonic acid ester, diethylether, ethyleneglycol monomethylether, ethyleneglycol dimethylether, ethyleneglycol monoethylether, ethyleneglycol phenylether, ethyleneglycol phenylmethylether, ethyleneglycol phenylethylether, diethyleneglycol dimethylether, diethyleneglycol ether, diethyleneglycol monomethylether, diethyleneglycol monoethylether, diethyleneglycol monomethylether acetate, diethyleneglycol monoethylether acetate, ethyleneglycol methylether acetate, ethyleneglycol ethylether acetate, 4-hydroxy-4-methyl-2-pentanone, 2-hydroxy ethyl propionate, 2-hydroxy-2-methyl ethyl propionate, ethoxy ethyl acetate, hydroxy ethyl acetate, 2-hydroxy-3-methyl methyl butanoate, 3-methoxy methyl propionate, 3-methoxy ethyl propionate, 3-ethoxy ethyl propionate, 3-ethoxy methyl propionate, methyl methoxy butanol, ethyl methoxy butanol, methyl ethoxy butanol, ethyl ethoxy butanol, tetrahydrofuran, dichloromethane, 1,2-dichloroethane, 1,4-dichlorobutane, trichloroethane, chlorobenzene, o-dichlorobenzene, hexane, heptane, octane, benzene, toluene, xylene, and the like, and mixtures of two or more.

The amount of solvent is not specifically limited in the liquid crystal alignment agent. In exemplary embodiments, the liquid crystal alignment agent may include the solventin an amount sufficient to provide a solid content of about 1 wt % to about 30 wt %, for example about 3 wt % to about 20 wt %.

In some embodiments, the liquid crystal alignment agent may include the solvent in an amount sufficient to provide a solid content of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the solvent can be selected to provide a solid content in a range from about any of the foregoing amounts to about any other of the foregoing amounts.

When the liquid crystal alignment agent has a solid content in an amount within the above range, the substrate surface may be less contaminated during the printing process to maintain suitable layer uniformity and suitable viscosity.

Thereby, it may prevent the deterioration of layer uniformity due to high viscosity during the printing process and provide appropriate light transmittance.

Other Additive(s)

The liquid crystal alignment agent according to one embodiment may further include one or more other additives.

An exemplary additive may include an epoxy compound. The epoxy compound can improve the reliability and the electro-optical properties, and the epoxy compound may include at least one kind of epoxy compound having 2 to 8 epoxy groups, for example, 2 to 4 epoxy groups.

The liquid crystal alignment agent may include the epoxy compound in an amount of about 0.1 parts by weight to about 50 parts by weight, for example about 1 part by weight to about 30 parts by weight, based on 100 parts by weight of the polymer. When the epoxy compound is included in an amount within the above range, it can provide appropriate printability and flatness during coating on the substrate, and also can easily improve reliability and electro-optical properties.

Examples of the epoxy compound may include without limitation a compound represented by the following Chemical Formula 25, or a combination thereof.

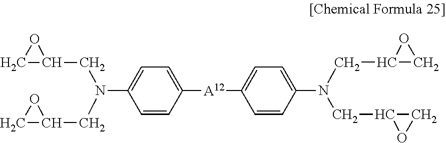

In Chemical Formula 25,

A¹² is a substituted or unsubstituted C6 to C12 aromatic organic group, a substituted or unsubstituted divalent C6 to C12 alicyclic organic group, or a substituted or unsubstituted divalent C6 to C12 aliphatic organic group, for example substituted or unsubstituted C1 to C6 alkylene.

Exemplary epoxy compounds may include without limitation N,N,N′,N′-tetraglycidyl-4,4′-diaminophenylmethane (TGDDM), N,N,N′,N′-tetraglycidyl-4,4′-diaminophenylethane, N,N,N′,N′-tetraglycidyl-4,4′-diaminophenylpropane, N,N,N′,N′-tetraglycidyl-4,4′-diaminophenylbutane, N,N,N′,N′-tetraglycidyl-4,4′-diaminobenzene, ethyleneglycoldiglycidylether, polyethyleneglycoldiglycidylether, propyleneglycoldiglycidylether, tripropyleneglycoldiglycidylether, polypropyleneglycoldiglycidylether, neopentylglycoldiglycidylether, 1,6-hexanedioldiglycidylether, glycerinediglycidylether, 2,2-dibromoneopentylglycoldiglycidylether, 1,3,5,6-tetraglycidyl-2,4-hexanediol, N,N,N′,N′-tetraglycidyl-1,4-phenylenediamine, N,N,N′,N′-tetraglycidyl-m-xylenediamine, N,N,N′,N′-tetraglycidyl-2,2′-dimethyl-4,4′-diaminobiphenyl, 2,2-bis[4-(N,N-diglycidyl-4-aminophenoxy)phenyl]propane, N,N,N′,N′-tetraglycidyl-4,4′-diaminodiphenylmethane, 1,3-bis(N,N-diglycidylaminomethyl)cyclohexane, 1,3-bis(N,N-diglycidylaminomethyl)benzene, and the like, and combinations thereof.

In addition, in order to improve the printability, the liquid crystal alignment agent may further include one or more other appropriate additives such as a surfactant or a coupling agent.

The liquid crystal alignment film according to another embodiment may be manufactured by using the liquid crystal alignment agent.

The liquid crystal alignment film may be formed by coating the liquid crystal alignment agent on a substrate. Exemplary methods of coating the liquid crystal alignment agent on the substrate may include without limitation spin coating, flexo printing, inkjet printing, and the like. Flexo printing may be generally used since it can provide excellent coating layer uniformity and can also easily provide a large size print.

The substrate is not specifically limited as long as it has a high transparency. Exemplary substrates may include without limitation glass substrates, plastic substrates such as acrylic substrates, polycarbonate substrates, and the like. In addition, the process can be simplified if the substrate is formed with an indium-tin oxide (ITO) electrode or the like for driving liquid crystal.

In order to increase coating uniformity, the process may include the step of pre-drying the coated substrateat a temperature of room temperature to about 200° C., for example, about 30° C. to about 150° C., or about 40° C. to about 120° C. for about 1 minute to about 100 minutes after uniformly coating the liquid crystal alignment agent on the substrate. The pre-drying process may help control volatilization of each component of liquid crystal alignment agent, which can help provide a uniform coating layer having no or minimal deviations.

Then, it may be baked at a temperature of about 80° C. to about 300° C., for example, a temperature of about 120° C. to about 280° C., for about 5 minutes to about 300 minutes to evaporate the solvent and to provide a liquid crystal alignment film.

Next, the liquid crystal alignment film can be photo-radiated to align the liquid crystal. For example, a substrate with the liquid crystal alignment film can be exposed to photo-radiation, or a liquid crystal cell or a liquid crystal panel fabricated using the liquid crystal alignment film can be exposed to photo-radiation. The liquid crystal cell or a panel may be exposed to photo-radiation by applying a predetermined voltage to the liquid crystal cell or liquid crystal panel to more precisely adjust a pretilt angle. For example, the photo-radiation applied for a liquid crystal cell or a liquid crystal panel may be performed by applying a voltage ranging from about 5 V to about 50 V to a liquid crystal cell or a liquid crystal panel and radiating light with energy ranging from about 1 J to about 40 J using a UV lamp with a wavelength of about 200 nm or more to align the liquid crystal on the surface of the liquid crystal alignment film.

According to another embodiment of the present invention, a liquid crystal display is provided that includes the liquid crystal alignment film.

### EXAMPLE

The following examples illustrate this disclosure in more detail. However, they are exemplary embodiments of this disclosure and are not limiting.

### Synthesis Example 1

### Preparation of Polyamic Acid (PAA-1)

1.00 mol of para-phenylenediamine (p-phenylenediamine) is placed in a four-necked flask with an agitator, a temperature controller, a nitrogen gas implanter, and a cooler, while nitrogen is passed through the flask, and N-methyl-2-pyrrolidone (NMP) is added thereto, preparing a mixed solution.

Next, 0.50 mol of solid 5-(2,5-dioxotetrahydrofuryl)-3-methylcyclohexene-1,2-dicarboxylic acid anhydride (DOCDA) and 0.50 mol of pyromellitic acid dianhydride (PMDA) are added to the mixed solution. The mixture is rigorously agitated.

The resulting reactant is maintained for reaction at a temperature ranging from 30° C. to 50° C. for 10 hours, preparing a polyamic acid resin. Then, an organic solvent prepared by mixing N-methyl-2-pyrrolidone and γ-butyrolactone is added to the polyamic acid resin. The mixture is agitated at room temperature for 24 hours, preparing a polyamic acid (PAA-1) solution. The polyamic acid (PAA-1) solution has a solid content of 10 wt %. In addition, the polyamic acid (PAA-1) has a weight average molecular weight of 270,000.

### Synthesis Example 2

### Preparation of Polyimide (SPI-1)

0.5 mol of para-phenylenediamine and 0.5 mol of 4,4′-methylene dianiline (MDA) are placed in a four-necked flask with an agitator, a temperature controller, a nitrogen gas implanter, and a cooler while nitrogen is passed through the flask, and N-methyl-2-pyrrolidone (NMP) is added thereto, preparing a mixed solution.

Next, 1.0 mol of solid 3,4-dicarboxy-1,2,3,4-tetrahydro-1-naphthalenesuccinic anhydride is added to the mixed solution. The mixture is rigorously agitated. The agitated reactant has a solid content of 20 wt %.

The reactant is maintained for reaction at a temperature ranging from 30° C. to 50° C. for 10 hours, preparing a polyamic acid resin. Then, N-methyl-2-pyrrolidone as an organic solvent is added to the polyamic acid resin. The mixture is agitated at a room temperature for 24 hours, preparing a polyamic acid solution.

Then, 3.0 mol of acetic acid anhydride and 5.0 mol of pyridine are added to the polyamic acid solution. The mixture is heated up to 80° C., reacted for 6 hours, and vacuum-distilled to remove a catalyst and a solvent, preparing a polyimide resin having a solid content of 20 wt %.

Next, an organic solvent prepared by mixing N-methyl-2-pyrrolidone, γ-butyrolactone, and 2-butylcellosolve in a volume ratio of 50:40:10 is added to the polyimide resin. The mixture is agitated at room temperature for 24 hours, preparing a polyimide (SPI-1) solution. The polyimide (SPI-1) solution has a solid content of 10 wt %. In addition, the polyimide (SPI-1) has a weight average molecular weight of 250,000.

### Synthesis Example 3

### Preparation of Polyimide (PSPI-1)

0.7 mol of para-phenylenediamine, 0.2 mol of 3,5-diaminophenyldecyl succinimide, which is a functional diamine represented by the following Chemical Formula 26, and 0.1 mol of (E)-4-(3-(2-(methacryloyloxy)ethoxy)-3-oxoprop-1-enyl)phenyl-3,5-diaminobenzoate represented by the following Chemical Formula 4 are placed in a four-necked flask with an agitator, a temperature controller, a nitrogen gas implanter, and a cooler while nitrogen is passed through the flask, and N-methyl-2-pyrrolidone (NMP) is added thereto, preparing a mixed solution.

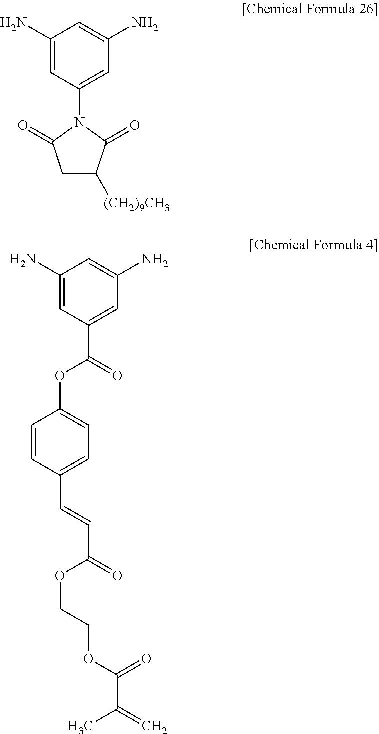

1.0 mol of solid 1,2,3,4-cyclobutanetetracarboxylic acid dianhydride is added to the mixed solution. The mixture is rigorously agitated. The reactant has a solid content of 20 wt %.

The reactant is maintained at a temperature ranging from 30° C. to 50° C. and reacted for 10 hours, preparing a polyamic acid resin. Next, N-methyl-2-pyrrolidone, an organic solvent, is added to the polyamic acid resin. The mixture is agitated at room temperature for 24 hours, preparing a polyamic acid solution.

Then, 3.0 mol of acetic acidanhydride and 5.0 mol of pyridine are added to the polyamic acid solution. The mixture is heated up to 80° C., reacted for 6 hours, and vacuum-distilled to remove a catalyst and a solvent, preparing a polyimide resin having a solid content of 20 wt %.

Next, an organic solvent prepared by mixing N-methyl-2-pyrrolidone, γ-butyrolactone and 2-butylcellosolve in a volume ratio of 50:40:10 is added to the polyimide resin. The mixture is agitated at room temperature for 24 hours, preparing a polyimide (PSPI-1) solution. The polyimide (PSPI-1) solution has a solid content of 10 wt %. In addition, the polyimide (PSPI-1) has a weight average molecular weight of 200,000.

### Synthesis Examples 4 to 18

### Preparation of Polyimide (PSPI-2) to Polyimide (PSPI-16)

Each polyimide (PSPI-2) to (PSPI-16) solution is respectively prepared according to the same method as Synthesis Example 3 except for changing the kind and amount of each diamine as provided in the following Table 1. The polyimide (PSPI-2) to (PSPI-16) solutions are sequentially referred to herein as Synthesis Examples 4 to 18.

Table 1 provides the solid contents of the polyimide (PSPI-2) to (PSPI-16) solutions. In addition, Table 1 also shows the weight average molecular weight of the polyimide (PSPI-2) to (PSPI-16).

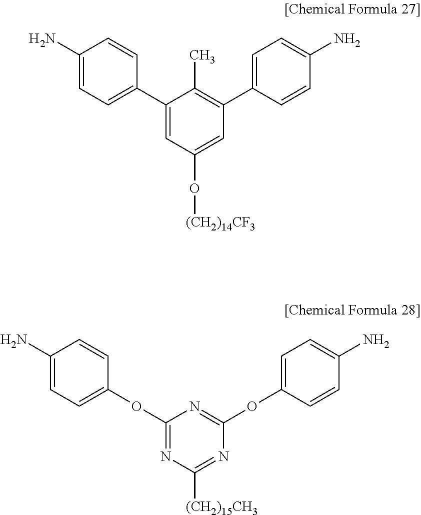

### Comparative Synthesis Examples 1 to 3

### Preparation of Polyimide (PSPI-17) to Polyimide (PSPI-19)

Each polyimide (PSPI-17) to (PSPI-19) solution is prepared according to the same method as Synthesis Example 3 except for changing the kind and amount of each diamine as provided in the following Table 1. The polyimide (PSPI-17) to polyimide (PSPI-19) solutions are sequentially referred to herein as Comparative Synthesis Examples 1 to 3.

Table 1 provides the solid contents of each polyimide (PSPI-17) to (PSPI-19) solution. In addition, Table 1 also provides the weight average molecular weight of each polyimide (PSPI-17) to (PSPI-19).

TABLE 1

| | | | | | Diamine of | | | Weight |
|---|---|---|---|---|---|---|---|---|
| | | | Functional | | Chemical | | | average |
| | Aromatic diamine | | diamine | | Formula 3 | | Solid | molecular |
| | | Amount | | Amount | | Amount | content | weight |
| | Kind | (mol) | Kind | (mol) | Kind | (mol) | (wt %) | (Mw) |
| Synthesis | para- | 1.00 | — | — | — | — | 10 | 270,000 |
| Example 1 | phenylene | | | | | | | |
| (polyamic | diamine | | | | | | | |
| acid, PAA-1) | | | | | | | | |
| Synthesis | para- | 0.5 | — | — | — | — | 10 | 250,000 |
| Example 2 | phenylene | | | | | | | |
| (polyimide, | diamine | | | | | | | |
| SPI-1) | 4,4′- | 0.5 | | | | | | |
| | methylene | | | | | | | |
| | dianiline | | | | | | | |
| Synthesis | para- | 0.7 | Chemical | 0.2 | Chemical | 0.1 | 10 | 200,000 |
| Example 3 | phenylene | | Formula | | Formula | | | |
| (polyimide, | diamine | | 26 | | 4 | | | |
| PSPI-1) | | | | | | | | |
| Synthesis | para- | 0.7 | Chemical | 0.2 | Chemical | 0.1 | 10 | 190,000 |
| Example 4 | phenylene | | Formula | | Formula | | | |
| (polyimide, | diamine | | 27 | | 4 | | | |
| PSPI-2) | | | | | | | | |
| Synthesis | para- | 0.7 | Chemical | 0.2 | Chemical | 0.1 | 10 | 190,000 |
| Example 5 | phenylene | | Formula | | Formula | | | |
| (polyimide, | diamine | | 28 | | 4 | | | |
| PSPI-3) | | | | | | | | |
| Synthesis | para- | 0.4 | Chemical | 0.2 | Chemical | 0.4 | 10 | 200,000 |
| Example 6 | phenylene | | Formula | | Formula | | | |
| (polyimide, | diamine | | 26 | | 4 | | | |
| PSPI-4) | | | | | | | | |
| Synthesis | para- | 0.4 | Chemical | 0.2 | Chemical | 0.4 | 10 | 210,000 |
| Example 7 | phenylene | | Formula | | Formula | | | |
| (polyimide, | diamine | | 27 | | 4 | | | |
| PSPI-5) | | | | | | | | |
| Synthesis | para- | 0.4 | Chemical | 0.2 | Chemical | 0.4 | 10 | 190,000 |
| Example 8 | phenylene | | Formula | | Formula | | | |
| (polyimide, | diamine | | 28 | | 4 | | | |
| PSPI-6) | | | | | | | | |
| Synthesis | para- | 0.1 | Chemical | 0.2 | Chemical | 0.7 | 10 | 180,000 |
| Example 9 | phenylene | | Formula | | Formula | | | |
| (polyimide, | diamine | | 26 | | 4 | | | |
| PSPI-7) | | | | | | | | |
| Synthesis | para- | 0.1 | Chemical | 0.2 | Chemical | 0.7 | 10 | 200,000 |
| Example 10 | phenylene | | Formula | | Formula | | | |
| (polyimide, | diamine | | 27 | | 4 | | | |
| PSPI-8) | | | | | | | | |
| Synthesis | para- | 0.1 | Chemical | 0.2 | Chemical | 0.7 | 10 | 190,000 |
| Example 11 | phenylene | | Formula | | Formula | | | |
| (polyimide, | diamine | | 28 | | 4 | | | |
| PSPI-9) | | | | | | | | |
| Synthesis | — | — | Chemical | 0.2 | Chemical | 0.8 | 10 | 180,000 |
| Example 12 | | | Formula | | Formula | | | |
| (polyimide, | | | 26 | | 4 | | | |
| PSPI-10) | | | | | | | | |
| Synthesis | — | — | Chemical | 0.2 | Chemical | 0.8 | 10 | 200,000 |
| Example 13 | | | Formula | | Formula | | | |
| (polyimide, | | | 27 | | 4 | | | |
| PSPI-11) | | | | | | | | |
| Synthesis | — | — | Chemical | 0.2 | Chemical | 0.8 | 10 | 190,000 |
| Example 14 | | | Formula | | Formula | | | |
| (polyimide, | | | 28 | | 4 | | | |
| PSPI-12) | | | | | | | | |
| Synthesis | para- | 0.3 | Chemical | 0.2 | Chemical | 0.5 | 10 | 200,000 |
| Example 15 | phenylene | | Formula | | Formula | | | |
| (polyimide, | diamine | | 26 | | 4 | | | |
| PSPI-13) | | | | | | | | |
| Synthesis | para- | 0.3 | Chemical | 0.2 | Chemical | 0.5 | 10 | 190,000 |
| Example 16 | phenylene | | Formula | | Formula | | | |
| (polyimide, | diamine | | 28 | | 4 | | | |
| PSPI-14) | | | | | | | | |
| Synthesis | — | — | Chemical | 0.2 | Chemical | 0.8 | 10 | 170,000 |
| Example 17 | | | Formula | | Formula | | | |
| (polyimide, | | | 26 | | 4 | | | |
| PSPI-15) | | | | | | | | |
| Synthesis | — | — | Chemical | 0.2 | Chemical | 0.8 | 10 | 160,000 |
| Example 18 | | | Formula | | Formula | | | |
| (polyimide, | | | 28 | | 4 | | | |
| PSPI-16) | | | | | | | | |
| Comp. | para- | 0.8 | Chemical | 0.2 | — | — | 10 | 190,000 |
| Synthesis | phenylene | | Formula | | | | | |
| Example 1 | diamine | | 26 | | | | | |
| (polyimide, | | | | | | | | |
| PSPI-17) | | | | | | | | |
| Comp. | para- | 0.8 | Chemical | 0.2 | — | — | 10 | 200,000 |
| Synthesis | phenylene | | Formula | | | | | |
| Example 2 | diamine | | 27 | | | | | |
| (polyimide, | | | | | | | | |
| PSPI-18) | | | | | | | | |
| Comp. | para- | 0.8 | Chemical | 0.2 | — | — | 10 | 210,000 |
| Synthesis | phenylene | | Formula | | | | | |
| Example 3 | diamine | | 28 | | | | | |
| (polyimide, | | | | | | | | |
| PSPI-19) | | | | | | | | |

### Examples 1 to 14

### Preparation of Liquid Crystal Alignment Agent (PSPI-1) to (PSPI-14)

The polyimide (PSPI-1) to (PSPI-14) solutions according to Synthesis Examples 3 to 16 are respectively used as provided in the following Table 2, preparing a liquid crystal alignment agent (PSPI-1) to (PSPI-14). The liquid crystal alignment agents (PSPI-1) to (PSPI-14) are sequentially referred to herein as Examples 1 to 14.

### Examples 15 to 17

### Preparation of Liquid Crystal Alignment Agents (PSPI/PAA-1) to (PSPI/PAA-3)

The polyamic acid (PAA-1) and the polyimide (PSPI-13) solutions according to Synthesis Examples 1 and 15 are respectively mixed as provided in the following Table 2, preparing each liquid crystal alignment agent (PSPI/PAA-1) to (PSPI/PAA-3). The liquid crystal alignment agents (PSPI/PAA-1) to (PSPI/PAA-3) are sequentially referred to herein as Examples 15 to 17.

### Example 18 to 20

### Preparation of Liquid Crystal Alignment Agents (PSPI/PAA-4) to (PSPI/PAA-6)

The polyamic acid (PAA-1) and the polyimide (PSPI-14) solutions according to Synthesis Examples 1 and 16 are respectively mixed as provided in the following Table 2, preparing each liquid crystal alignment agent (PSPI/PAA-4) to (PSPI/PAA-6). The liquid crystal alignment agents (PSPI/PAA-4) to (PSPI/PAA-6) are sequentially referred to herein as Examples 18 to 20.

### Examples 21 to 23

### Preparation of Liquid Crystal Alignment Agents (PSPI/SPI-1) to (PSPI/SPI-3)

The polyimide (SPI-1) and (PSPI-13) solutions according to Synthesis Examples 2 and 15 are mixed as provided in the following Table 2, preparing each liquid crystal alignment agent (PSPI/SPI-1) to (PSPI/SPI-3). The liquid crystal alignment agents (PSPI/SPI-1) to (PSPI/SPI-3) are sequentially referred to herein as Examples 21 to 23.

### Examples 24 to 26

### Preparation of Liquid Crystal Alignment Agents (PSPI/SPI-4) to (PSPI/SPI-6)

The polyimide (SPI-1) and (PSPI-14) solutions according to Synthesis Examples 2 and 16 are mixed as provided in the following Table 2, preparing each liquid crystal alignment agent (PSPI/SPI-4) to (PSPI/SPI-6). The liquid crystal alignment agents (PSPI/SPI-4) to (PSPI/SPI-6) are sequentially referred to herein as Examples 24 to 26.

### Examples 27 to 29

### Preparation of Liquid Crystal Alignment Agents (PSPI/PAA-7) to (PSPI/PAA-9)

The polyamic acid (PAA-1) solution according to Synthesis Example 1 and the polyimide (PSPI-15) solution according to Synthesis Example 17 are mixed in a ratio provided in the following Table 2 preparing liquid crystal alignment agents (PSPI/PAA-7) to (PSPI/PAA-9). The liquid crystal alignment agents (PSPI/PAA-7) to (PSPI/PAA-9) are sequentially referred to herein as Examples 27 to 29.

### Examples 30 to 32

### Preparation of Liquid Crystal Alignment Agents (PSPI/PAA-10) to (PSPI/PAA-12)

The polyamic acid (PAA-1) solution according to Synthesis Example 1 and the polyimide (PSPI-16) solution according to Synthesis Example 18 are mixed in a ratio provided in the following Table 2, preparing liquid crystal alignment agents (PSPI/PAA-10) to (PSPI/PAA-12). The liquid crystal alignment agents (PSPI/PAA-10) to (PSPI/PAA-12) are sequentially referred to herein as Examples 30 to 32.

### Examples 33 to 35

### Preparation of Liquid Crystal Alignment Agents (PSPI/SPI-7) to (PSPI/SPI-9)

The polyimide (SPI-1) solution according to Synthesis Example 2 and the polyimide (PSPI-15) solution according to Synthesis Example 17 are mixed in a ratio provided in the following Table 2, preparing liquid crystal alignment agents (PSPI/SPI-7) to (PSPI/SPI-9). The liquid crystal alignment agents (PSPI/SPI-7) to (PSPI/SPI-9) are sequentially referred to herein as Examples 33 to 35.

### Examples 36 to 38

### Preparation of Liquid Crystal Alignment Agents (PSPI/SPI-10) to (PSPI/SPI-12)

The polyimide (SPI-1) solution according to Synthesis Example 2 and the polyimide (PSPI-16) solution according to Synthesis Example 18 are mixed in a ratio provided in the following Table 2, preparing liquid crystal alignment agents (PSPI/SPI-10) to (PSPI/SPI-12). The liquid crystal alignment agents (PSPI/SPI-10) to (PSPI/SPI-12) are sequentially referred to herein as Examples 36 to 38.

### Comparative Examples 1 to 3

### Preparation of Liquid Crystal Alignment Agents (PSPI-17) to (PSPI-19)

The polyimide (PSPI-17) solution according to Comparative Synthesis Example 1 to the polyimide (PSPI-19) solution according to Comparative Synthesis Example 3 are mixed as shown in the following Table 2, preparing liquid crystal alignment agents (PSPI-17) to (PSPI-19). The liquid crystal alignment agents (PSPI-17) to (PSPI-19) are sequentially referred to herein as Comparative Examples 1 to 3.

TABLE 2

| | Polyamic acid(PAA) | | Polyimide (SPI) | | Polyimide (PSPI) | |
|---|---|---|---|---|---|---|
| | solution | | solution | | solution | |
| | | Amount | | Amount | | Amount |
| | Kind | (g) | Kind | (g) | Kind | (g) |
| Example 1 | — | — | — | — | Synthesis | 100 |
| (liquid crystal alignment | | | | | Example 3 | |
| agent(PSPI-1)) | | | | | (PSPI-1 | |
| | | | | | solution) | |
| Example 2 | — | — | — | — | Synthesis | 100 |
| (liquid crystal alignment | | | | | Example 4 | |
| agent(PSPI-2)) | | | | | (PSPI-2 | |
| | | | | | solution) | |
| Example 3 | — | — | — | — | Synthesis | 100 |
| (liquid crystal alignment | | | | | Example 5 | |
| agent(PSPI-3)) | | | | | (PSPI-3 | |
| | | | | | solution) | |
| Example 4 | — | — | — | — | Synthesis | 100 |
| (liquid crystal alignment | | | | | Example 6 | |
| agent(PSPI-4)) | | | | | (PSPI-4 | |
| | | | | | solution) | |
| Example 5 | — | — | — | — | Synthesis | 100 |
| (liquid crystal alignment | | | | | Example 7 | |
| agent(PSPI-5)) | | | | | (PSPI-5 | |
| | | | | | solution) | |
| Example 6 | — | — | — | — | Synthesis | 100 |
| (liquid crystal alignment | | | | | Example 8 | |
| agent(PSPI-6)) | | | | | (PSPI-6 | |
| | | | | | solution) | |
| Example 7 | — | — | — | — | Synthesis | 100 |
| (liquid crystal alignment | | | | | Example 9 | |
| agent(PSPI-7)) | | | | | (PSPI-7 | |
| | | | | | solution) | |
| Example 8 | — | — | — | — | Synthesis | 100 |
| (liquid crystal alignment | | | | | Example 10 | |
| agent(PSPI-8)) | | | | | (PSPI-8 | |
| | | | | | solution) | |
| Example 9 | — | — | — | — | Synthesis | 100 |
| (liquid crystal alignment | | | | | Example 11 | |
| agent(PSPI-9)) | | | | | (PSPI-9 | |
| | | | | | solution) | |
| Example 10 | — | — | — | — | Synthesis | 100 |
| (liquid crystal alignment | | | | | Example 12 | |
| agent(PSPI-10)) | | | | | (PSPI-10 | |
| | | | | | solution) | |
| Example 11 | — | — | — | — | Synthesis | 100 |
| (liquid crystal alignment | | | | | Example 13 | |
| agent(PSPI-11)) | | | | | (PSPI-11 | |
| | | | | | solution) | |
| Example 12 | — | — | — | — | Synthesis | 100 |
| (liquid crystal alignment | | | | | Example 14 | |
| agent(PSPI-12)) | | | | | (PSPI-12 | |
| | | | | | solution) | |
| Example 13 | — | — | — | — | Synthesis | 100 |
| (liquid crystal alignment | | | | | Example 15 | |
| agent(PSPI-13)) | | | | | (PSPI-13 | |
| | | | | | solution) | |
| Example 14 | — | — | — | — | Synthesis | 100 |
| (liquid crystal alignment | | | | | Example 16 | |
| agent(PSPI-14)) | | | | | (PSPI-14 | |
| | | | | | solution) | |
| Example 15 | Synthesis | 90 | — | — | Synthesis | 10 |
| (liquid crystal alignment | Example 1 | | | | Example 15 | |
| agent(PSPI/PAA-1)) | (PAA-1 | | | | (PSPI-13 | |
| | solution) | | | | solution) | |
| Example 16 | Synthesis | 70 | — | — | Synthesis | 30 |
| (liquid crystal alignment | Example 1 | | | | Example 15 | |
| agent(PSPI/PAA-2)) | (PAA-1 | | | | (PSPI-13 | |
| | solution) | | | | solution) | |
| Example 17 | Synthesis | 50 | — | — | Synthesis | 50 |
| (liquid crystal alignment | Example 1 | | | | Example 15 | |
| agent(PSPI/PAA-3)) | (PAA-1 | | | | (PSPI-13 | |
| | solution) | | | | solution) | |
| Example 18 | Synthesis | 90 | — | — | Synthesis | 10 |
| (liquid crystal alignment | Example 1 | | | | Example 16 | |
| agent(PSPI/PAA-4)) | (PAA-1 | | | | (PSPI-14 | |
| | solution) | | | | solution) | |
| Example 19 | Synthesis | 70 | — | — | Synthesis | 30 |
| (liquid crystal alignment | Example 1 | | | | Example 16 | |
| agent(PSPI/PAA-5)) | (PAA-1 | | | | (PSPI-14 | |
| | solution) | | | | solution) | |
| Example 20 | Synthesis | 50 | — | — | Synthesis | 50 |
| (liquid crystal alignment | Example 1 | | | | Example 16 | |
| agent(PSPI/PAA-6)) | (PAA-1 | | | | (PSPI-14 | |
| | solution) | | | | solution) | |
| Example 21 | — | — | Synthesis | 90 | Synthesis | 10 |
| (liquid crystal alignment | | | Example 2 | | Example 15 | |
| agent(PSPI/SPI-1)) | | | (SPI-1 | | (PSPI-13 | |
| | | | solution) | | solution) | |
| Example 22 | — | — | Synthesis | 70 | Synthesis | 30 |
| (liquid crystal alignment | | | Example 2 | | Example 15 | |
| agent(PSPI/SPI-2)) | | | (SPI-1 | | (PSPI-13 | |
| | | | solution) | | solution) | |
| Example 23 | — | — | Synthesis | 50 | Synthesis | 50 |
| (liquid crystal alignment | | | Example 2 | | Example 15 | |
| agent(PSPI/SPI-3)) | | | (SPI-1 | | (PSPI-13 | |
| | | | solution) | | solution) | |
| Example 24 | — | — | Synthesis | 90 | Synthesis | 10 |
| (liquid crystal alignment | | | Example 2 | | Example 16 | |
| agent(PSPI/SPI-4)) | | | (SPI-1 | | (PSPI-14 | |
| | | | solution) | | solution) | |
| Example 25 | — | — | Synthesis | 70 | Synthesis | 30 |
| (liquid crystal alignment | | | Example 2 | | Example 16 | |
| agent(PSPI/SPI-5)) | | | (SPI-1 | | (PSPI-14 | |
| | | | solution) | | solution) | |
| Example 26 | — | — | Synthesis | 50 | Synthesis | 50 |
| (liquid crystal alignment | | | Example 2 | | Example 16 | |
| agent(PSPI/SPI-6)) | | | (SPI-1 | | (PSPI-14 | |
| | | | solution) | | solution) | |
| Example 27 | Synthesis | 90 | — | — | Synthesis | 10 |
| (liquid crystal alignment | Example 1 | | | | Example 17 | |
| agent(PSPI/PAA-7)) | (PAA-1 | | | | (PSPI-15 | |
| | solution) | | | | solution) | |
| Example 28 | Synthesis | 70 | — | — | Synthesis | 30 |
| (liquid crystal alignment | Example 1 | | | | Example 17 | |
| agent(PSPI/PAA-8)) | (PAA-1 | | | | (PSPI-15 | |
| | solution) | | | | solution) | |
| Example 29 | Synthesis | 50 | — | — | Synthesis | 50 |
| (liquid crystal alignment | Example 1 | | | | Example 17 | |
| agent(PSPI/PAA-9)) | (PAA-1 | | | | (PSPI-15 | |
| | solution) | | | | solution) | |
| Example 30 | Synthesis | 90 | — | — | Synthesis | 10 |
| (liquid crystal alignment | Example 1 | | | | Example 18 | |
| agent(PSPI/PAA-10)) | (PAA-1 | | | | (PSPI-16 | |
| | solution) | | | | solution) | |
| Example 31 | Synthesis | 70 | — | — | Synthesis | 30 |
| (liquid crystal alignment | Example 1 | | | | Example 18 | |
| agent(PSPI/PAA-11)) | (PAA-1 | | | | (PSPI-16 | |
| | solution) | | | | solution) | |
| Example 32 | Synthesis | 50 | — | — | Synthesis | 50 |
| (liquid crystal alignment | Example 1 | | | | Example 18 | |
| agent(PSPI/PAA-12)) | (PAA-1 | | | | (PSPI-16 | |
| | solution) | | | | solution) | |
| Example 33 | — | — | Synthesis | 90 | Synthesis | 10 |
| (liquid crystal alignment | | | Example 2 | | Example 17 | |
| agent(PSPI/SPI-7)) | | | (SPI-1 | | (PSPI-15 | |
| | | | solution) | | solution) | |
| Example 34 | — | — | Synthesis | 70 | Synthesis | 30 |
| (liquid crystal alignment | | | Example 2 | | Example 17 | |
| agent(PSPI/SPI-8)) | | | (SPI-1 | | (PSPI-15 | |
| | | | solution) | | solution) | |
| Example 35 | — | — | Synthesis | 50 | Synthesis | 50 |
| (liquid crystal alignment | | | Example 2 | | Example 17 | |
| agent(PSPI/SPI-9)) | | | (SPI-1 | | (PSPI-15 | |
| | | | solution) | | solution) | |
| Example 36 | — | — | Synthesis | 90 | Synthesis | 10 |
| (liquid crystal alignment | | | Example 2 | | Example 18 | |
| agent(PSPI/SPI-10)) | | | (SPI-1 | | (PSPI-16 | |
| | | | solution) | | solution) | |
| Example 37 | — | — | Synthesis | 70 | Synthesis | 30 |
| (liquid crystal alignment | | | Example 2 | | Example 18 | |
| agent(PSPI/SPI-11)) | | | (SPI-1 | | (PSPI-16 | |
| | | | solution) | | solution) | |
| Example 38 | — | — | Synthesis | 50 | Synthesis | 50 |
| (liquid crystal alignment | | | Example 2 | | Example 18 | |
| agent(PSPI/SPI-12)) | | | (SPI-1 | | (PSPI-16 | |
| | | | solution) | | solution) | |
| Comparative Example 1 | — | — | — | — | Comp. | 100 |
| (liquid crystal alignment | | | | | Synthesis | |
| agent(PSPI-17)) | | | | | Example 1 | |
| | | | | | (PSPI-17 | |
| | | | | | solution) | |
| Comparative Example 2 | — | — | — | — | Comp. | 100 |
| (liquid crystal alignment | | | | | Synthesis | |
| agent(PSPI-18)) | | | | | Example 2 | |
| | | | | | (PSPI-18 | |
| | | | | | solution) | |
| Comparative Example 3 | — | — | — | — | Comp. | 100 |
| (liquid crystal alignment | | | | | Synthesis | |
| agent(PSPI-19)) | | | | | Example 3 | |
| | | | | | (PSPI-19 | |
| | | | | | solution) | |

### Experimental Example 1

### Light Transmittance

The liquid crystal alignment agents are respectively used to fabricate a liquid crystal cell and then evaluated regarding light transmittance. The liquid crystal cell is fabricated as follows.

A glass substrate with indium-tin oxide (ITO) having a standard size is patterned using a photolithography process to remove the ITO except for an 15 mm×15 mm square ITO shape and an electrode ITO shape.

The liquid crystal alignment agents according to the Examples 1 to 38 and Comparative Examples 1 to 3, respectively, are spin-coated to form a 0.1 μm thick layer on the patterned ITO substrate and cured at 80° C. and 220° C., fabricating two sheets of a substrate per each liquid crystal alignment agent.

Then, a spacer is distributed on one sheet of the substrate, and a sealant is applied on the other substrate. Two sheets of the substrates are hot-pressed and assembled to maintain a cell gap of 3.25 μm. Next, liquid crystal for a VA mode is implanted into an empty cell using capillarity. The cell is sealed with a UV curing bond for end-sealing, fabricating a liquid crystal cell for testing.

A voltage of DC 30V is applied to the liquid crystal cell and then the liquid crystal cell is photo-radiated with 20J of energy to align liquid crystals on the surface of the liquid crystal alignment film in a desired direction.

A voltage of AC 6.5V is applied to each liquid crystal cell and then the amount of transmitted light therein is measured. When the liquid crystal cells fabricated by using the liquid crystal alignment agents according to Comparative Examples 1 to 3 are regarded to have 100% of the amount of light transmission at 400 nm to 750 nm, the liquid crystal cells fabricated by using the liquid crystal alignment agents according to Examples 1 to 38 are compared therewith regarding the amount of light transmission at 400 nm to 750 nm. The results are provided in the following Table 3.

### Experimental Example 2

### Response Time

Each liquid crystal test cell according to Experimental Example 1 are alternatively applied with a voltage of AC 6.5V and AC 0.1V and then transmission change at real time is recorded by using an oscilloscope (when a voltage of AC 6.5V is applied to a cell, the cell has a transmission change increasing from 0% to 100%, while a voltage of AC 0.1V is applied to a cell, the cell has a transmission change decreasing from 100% to 0%). The response time indicates the sum of rising time (Tₒₙ) taking for transmission to increase from 10% to 90% and falling time (T_{off}) taking for transmission to decrease from 90% to 10%. However, the rising time (Tₒₙ) is only measured herein. The results are provided in the following Table 3.

### Experimental Example 3

### Printability

The liquid crystal alignment agents according to Examples 1 to 38 and Comparative Examples 1 and 2, respectively, are applied on a glass substrate with a 10 cm×10 cm indium-tin oxide (ITO), spin-coated to form a uniform 0.1 μm thick layer, put on a 80° C. hot plate to remove a solvent, and cured at 210° C., fabricating a liquid crystal alignment film.

Spreading and rolling characteristics of the liquid crystal alignment films are examined with the bare eye and an optical microscope to evaluate printability. The results are provided in the following Table 3.

<Printability Evaluation Reference>

Good: pinhole number of less than 15

Middle: pinhole number of 15 to 30

Bad: pinhole number of more than 30

TABLE 3

| | Light | Response time | |
|---|---|---|---|
| Samples | transmittance (%) | (rising, ms) | Printability |
| Example 1 | 101 | 19 | Good |
| Example 2 | 101 | 19 | Good |
| Example 3 | 101 | 19 | Good |
| Example 4 | 103 | 17 | Good |
| Example 5 | 103 | 17 | Good |
| Example 6 | 103 | 17 | Good |
| Example 7 | 105 | 15 | Middle |
| Example 8 | 105 | 15 | Middle |
| Example 9 | 105 | 15 | Middle |
| Example 10 | 105 | 14 | Middle |
| Example 11 | 105 | 14 | Middle |
| Example 12 | 105 | 14 | Middle |
| Example 13 | 105 | 20 | Middle |
| Example 14 | 105 | 20 | Middle |
| Example 15 | 101 | 13 | Good |
| Example 16 | 103 | 14 | Good |
| Example 17 | 105 | 15 | Good |
| Example 18 | 101 | 13 | Good |
| Example 19 | 103 | 14 | Good |
| Example 20 | 103 | 15 | Good |
| Example 21 | 105 | 13 | Middle |
| Example 22 | 105 | 14 | Middle |
| Example 23 | 105 | 15 | Middle |
| Example 24 | 105 | 13 | Middle |
| Example 25 | 105 | 14 | Middle |
| Example 26 | 105 | 15 | Middle |
| Example 27 | 101 | 12 | Good |
| Example 28 | 101 | 13 | Good |
| Example 29 | 103 | 14 | Good |
| Example 30 | 103 | 12 | Good |
| Example 31 | 105 | 13 | Good |
| Example 32 | 105 | 14 | Good |
| Example 33 | 101 | 12 | Middle |
| Example 34 | 101 | 13 | Middle |
| Example 35 | 105 | 14 | Middle |
| Example 36 | 103 | 12 | Middle |
| Example 37 | 103 | 13 | Middle |
| Example 38 | 105 | 14 | Middle |
| Comparative | 100 | 25 | Middle |
| Example 1 | | | |
| Comparative | 100 | 25 | Middle |
| Example 2 | | | |
| Comparative | 100 | 25 | Middle |
| Example 3 | | | |

As shown in Table 3, the liquid crystal cells fabricated by using the liquid crystal alignment agents according to Examples 1 to 38 had 1% to 5% improved light transmittance compared with the ones fabricated by using the liquid crystal alignment agent according to Comparative Examples 1 to 3.

In addition, the liquid crystal cells fabricated by using the liquid crystal alignment agents according to Examples 1 to 38 had 5 ms to 13 ms improved response time compared with the ones fabricated by using the liquid crystal alignment agent according to Comparative Examples 1 to 3.

Furthermore, the liquid crystal cells fabricated by using the liquid crystal alignment agents according to Examples 1 to 38 had excellent or at least equivalent printability compared with the ones fabricated by using the liquid crystal alignment agent according to Comparative Examples 1 to 3.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A liquid crystal alignment agent comprising a first polymer including polyamic acid including a repeating unit represented by the following Chemical Formula 1, polyimide including a repeating unit represented by the following Chemical Formula 2, or a combination thereof: 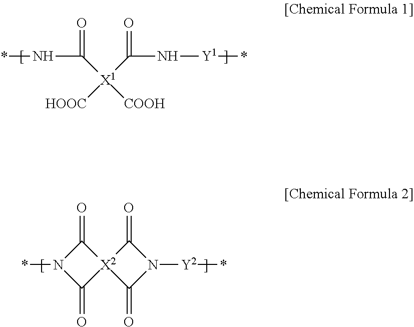
wherein, in Chemical Formulae 1 and 2,
X¹ and X² are the same or different and are each independently a tetravalent organic group derived from alicyclic acid dianhydride or aromatic acid dianhydride, and
Y¹ and Y² are the same or different, and are each independently a divalent organic group derived from diamine wherein the diamine includes a diamine represented by the following Chemical Formula 3, 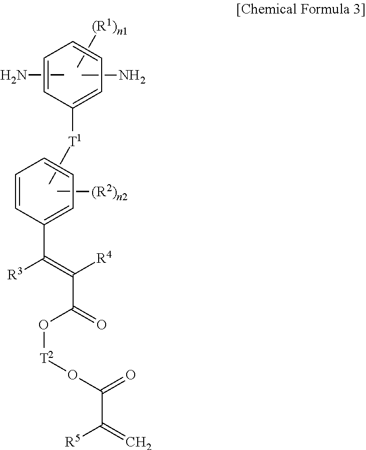
wherein, in Chemical Formula 3,
T¹ is COO, OCO or O,
T² is a single bond or a substituted or unsubstituted divalent C1 to C30 aliphatic organic group,
R¹ to R⁵ are the same or different and are independently hydrogen or substituted or unsubstituted C1 to C30 aliphatic organic group,
n₁ is an integer ranging from 0 to 3, and
n₂ is an integer ranging from 0 to 4.

2. The liquid crystal alignment agent of claim 1, wherein the diamine represented by the above Chemical Formula 3 comprises at least one compound represented by the following Chemical Formulae 4 to 8 or a combination thereof:

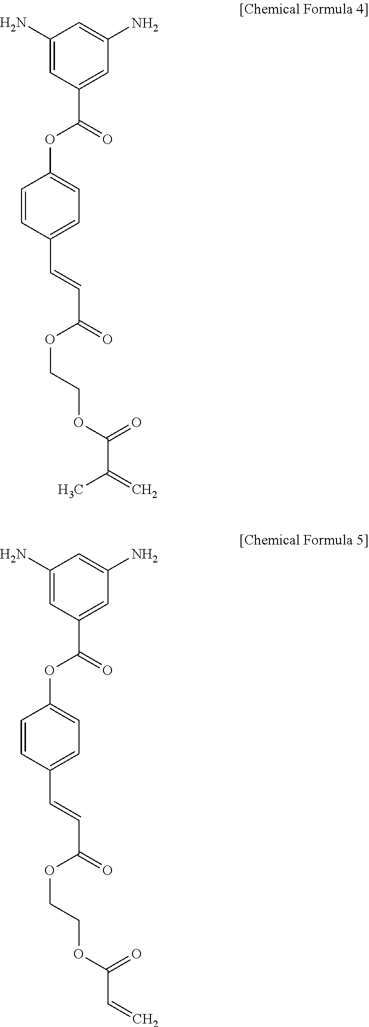

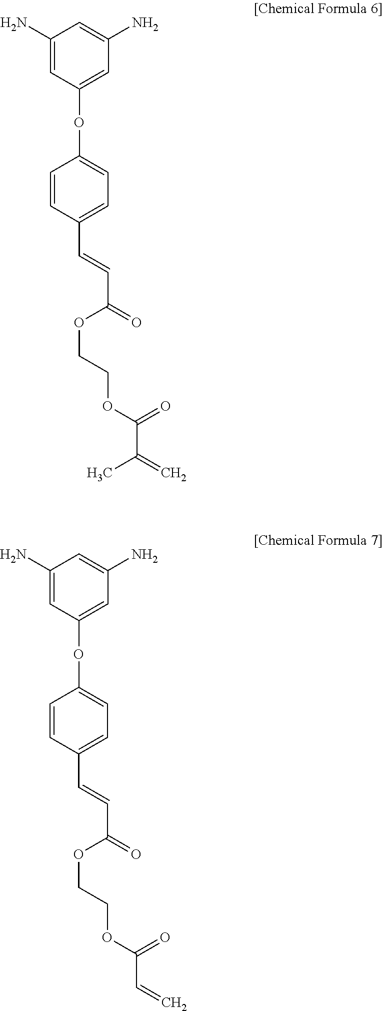

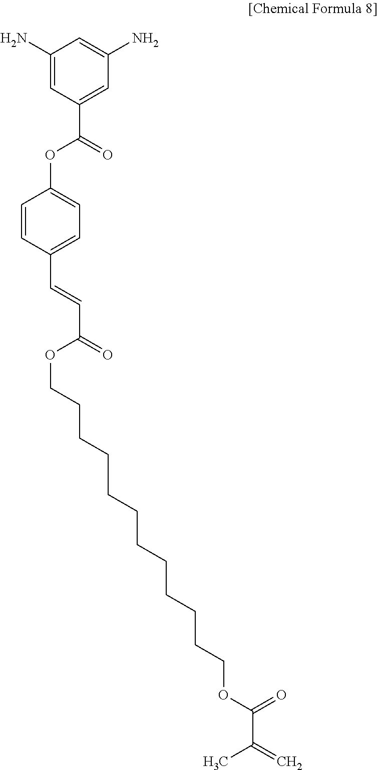

3. The liquid crystal alignment agent of claim 1, wherein the diamine further comprises an aromatic diamine represented by the following Chemical Formulae 18 to 21, a functional diamine represented by the following Chemical Formulae 22 to 24, or a combination thereof: 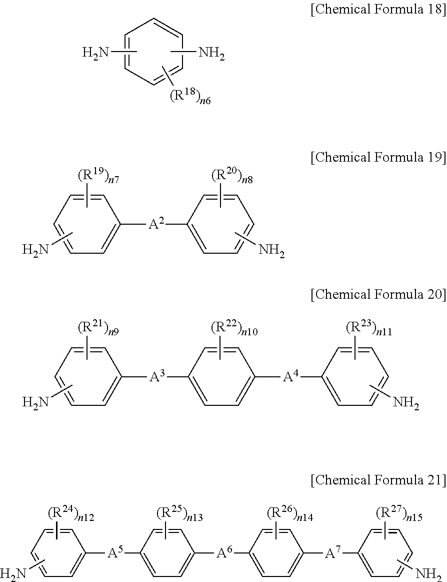
wherein, in Chemical Formulae 18 to 21,
R¹⁸ to R²⁷ are the same or different and are each independently substituted or unsubstituted alkyl, substituted or unsubstituted aryl, or substituted or unsubstituted heteroaryl, wherein the alkyl, the aryl, or the heteroaryl optionally includes —O—, —COO—, —CONH—, —OCO—, or a combination thereof,
A² to A⁷ are the same or different and are each independently a single bond, O, SO₂ or C(R¹⁰³)(R¹⁰⁴), wherein R¹⁰³ and R¹⁰⁴ are the same or different and are each independently hydrogen or substituted or unsubstituted C1 to C6 alkyl, and
n₆ to n₁₅ are each independently integers ranging from 0 to 4, 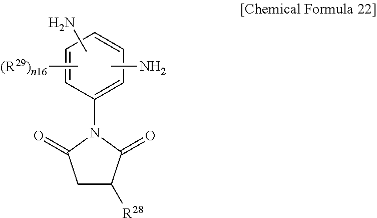
wherein, in Chemical Formula 22,
R²⁸ is hydrogen, substituted or unsubstituted C1 to C30 alkyl, substituted or unsubstituted C6 to C30 aryl, or substituted or unsubstituted C2 to C30 heteroaryl,
R²⁹ is the same or different and are each independently substituted or unsubstituted C1 to C30 alkyl, substituted or unsubstituted C6 to C30 aryl, or substituted or unsubstituted C2 to C30 heteroaryl,
n₁₆ is an integer ranging from 0 to 3, and 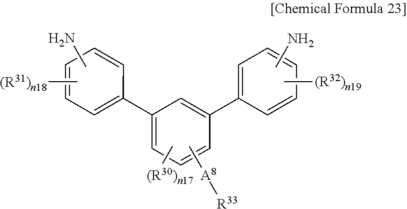
wherein, in Chemical Formula 23,
R³⁰, R³¹ and R³² are the same or different and are each independently substituted or unsubstituted alkyl, substituted or unsubstituted aryl, or substituted or unsubstituted heteroaryl,
A⁸ is a single bond, O, COO, CONH, OCO, or substituted or unsubstituted C1 to C10 alkylene,
R³³ is hydrogen, substituted or unsubstituted alkyl, substituted or unsubstituted aryl, or substituted or unsubstituted heteroaryl, wherein the alkyl, the aryl, or the heteroaryl optionally includes —O—, —COO—, —CONH—, —OCO—, or a combination thereof,
n₁₇ is an integer of 0 to 3, and
n₁₈ and n₁₉ are each independently integers ranging from 0 to 4, 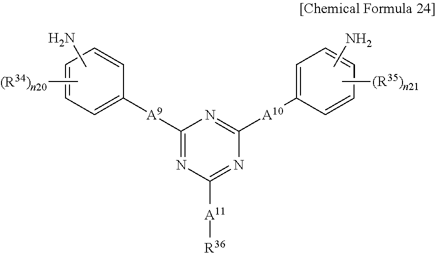
wherein, in Chemical Formula 24,
R³⁴ and R³⁵ are the same or different and are each independently substituted or unsubstituted alkyl, substituted or unsubstituted aryl, or substituted or unsubstituted heteroaryl,
n₂₀ and n₂₁ are each independently integers ranging from 0 to 4,
R³⁶ is hydrogen, substituted or unsubstituted alkyl, substituted or unsubstituted aryl, or substituted or unsubstituted heteroaryl,
A⁹ and A¹⁰ are the same or different and are each independently a single bond, O, or COO, and
A¹¹ is a single bond, O, COO, CONH or OCO.

4. The liquid crystal alignment agent of claim 3, wherein when the diamine includes the diamine represented by Chemical Formula 3 and the functional diamine, and wherein the diamine comprises the diamine represented by Chemical Formula 3 and the functional diamine at a mole ratio of about 99:1 to about 70:30.

5. The liquid crystal alignment agent of claim 3, wherein when the diamine includes the diamine represented by Chemical Formula 3 and the aromatic diamine, and wherein the diamine comprises the diamine represented by Chemical Formula 3 and the aromatic diamine at a mole ratio of about 99:1 to about 70:30.

6. The liquid crystal alignment agent of claim 3, wherein when the diamine includes the diamine represented by Chemical Formula 3, the aromatic diamine and the functional diamine, and wherein the diamine comprises about 1 mol % to about 80 mol % of the diamine represented by Chemical Formula 3, about 1 mol % to about 80 mol % of the aromatic diamine, and about 1 mol % to about 50 mol % of the functional diamine based on based on the total amount of the diamine.

7. The liquid crystal alignment agent of claim 1, wherein the polyamic acid including the repeating unit represented by the above Chemical Formula 1 and polyimide including the repeating unit represented by the above Chemical Formula 2 each have a weight average molecular weight (Mw) of 10,000 g/mol to about 300,000 g/mol, respectively.

8. The liquid crystal alignment agent of claim 1, wherein the first polymer comprises the polyamic acid including the repeating unit represented by the above Chemical Formula 1 and the polyimide including the repeating unit represented by the above Chemical Formula 2 at a weight ratio of about 1:99 to about 50:50.

9. The liquid crystal alignment agent of claim 1, wherein the liquid crystal alignment agent further comprises a second polymer including polyamic acid including the repeating unit represented by the following Chemical Formula 9, polyimide including the repeating unit represented by the following Chemical Formula 10, or a combination thereof. 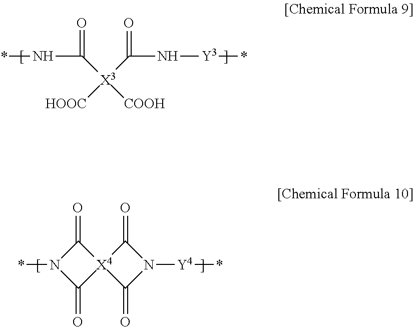
wherein, in Chemical Formulae 9 and 10,
X³ and X⁴ are the same or different and are each independently a tetravalent organic group derived from alicyclic acid dianhydride or aromatic acid dianhydride, and
Y³ and Y⁴ are the same or different and are each independently a divalent organic group derived from diamine.

10. The liquid crystal alignment agent of claim 9, wherein the polyamic acid including the repeating unit represented by the above Chemical Formula 9 and the polyimide including the repeating unit represented by the above Chemical Formula 10 each have a weight average molecular weight of about 10,000 g/mol to about 300,000 g/mol, respectively.

11. The liquid crystal alignment agent of claim 9, wherein the second polymer comprises the polyamic acid including the repeating unit represented by the above Chemical Formula 9 and the polyimide including the repeating unit represented by the above Chemical Formula 10 at a weight ratio of about 1:99 to about 50:50.

12. The liquid crystal alignment agent of claim 9, wherein the liquid crystal alignment agent comprises the first polymer and the second polymer at a weight ratio of about 10:90 to about 50:50.

13. The liquid crystal alignment agent of claim 1, wherein the liquid crystal alignment agent has a solid content of about 1 wt % to about 30 wt %.

14. A liquid crystal alignment film manufactured by applying the liquid crystal alignment agent according to claim 1 to a substrate

15. A liquid crystal display including the liquid crystal alignment film according to claim 14.
